(19) United States
(12) Patent Application Publication
(10) Pub. No.: US 2024/0393741 A1
(43) Pub. Date: Nov. 28, 2024

(54) DEVELOPING CARTRIDGE

(71) Applicant: Zhuhai Ninestar Information Technology Co., Ltd, Zhuhai (CN)

(72) Inventors: Wenjie ZHAO, Zhuhai (CN); Likun ZENG, Zhuhai (CN); Xinyu WU, Zhuhai (CN); Qin LUO, Zhuhai (CN); Junyu TAO, Zhuhai (CN); Hailong MA, Zhuhai (CN); Haoli HUANG, Zhuhai (CN); Mingdong CHEN, Zhuhai (CN); Xiaoming LIANG, Zhuhai (CN); Yang JIN, Zhuhai (CN)

(21) Appl. No.: 18/797,232

(22) Filed: Aug. 7, 2024

Related U.S. Application Data
(63) Continuation of application No. PCT/CN2023/096050, filed on May 24, 2023.

(30) Foreign Application Priority Data
May 26, 2022 (CN) 202221289944.1
Nov. 9, 2022 (CN) 202222989495.8
Apr. 4, 2023 (CN) 202320737723.4

(51) Int. Cl. G03G 21/18; G03G 15/08

(52) U.S. Cl. CPC G03G 21/1864; G03G 15/0877; G03G 21/1835; G03G 21/1867; G03G 2215/0634

(57) ABSTRACT

The present disclosure provides a developing cartridge. The developing cartridge includes a developing roller; a developing frame, where the developing frame includes a cartridge body, a driving-end cover and a conductive-end cover, the driving-end cover is at an end of the cartridge body along a length direction of the cartridge body, and the conductive-end cover is at another end of the cartridge body along the length direction of the cartridge body; a separation contact part; a tension spring; a force-receiving part, where the force-receiving part is configured to receive and transmit a driving force to rotate the developing roller; and an electrode assembly, where the electrode assembly is at an inner side of the conductive-end cover and electrically connected to an end of the developing roller; and an opening is formed on the conductive-end cover, and a portion of the electrode assembly is exposed through the opening.

### CROSS-REFERENCE TO RELATED APPLICATION

This application is a continuation application of PCT Patent Application No. PCT/CN2023/096050, filed on May 24, 2023, which claims the priority to Chinese patent application No. 202221289944.1, filed on May 26, 2022, No. 202222989495.8, filed on Nov. 9, 2022, and No. 202320737723.4, filed on Apr. 4, 2023, the entirety of all of which is incorporated herein by reference.

### TECHNICAL FIELD

The present disclosure generally relates to the field of image-forming apparatus technology and, more particularly, relates to a developing cartridge.

### BACKGROUND

Image-forming apparatuses form images on recording media. Examples of the image-forming apparatuses may include an electronic copying machine, an electrophotographic printer (e.g., a laser beam printer, a light-emitting (LED) printer or the like), a fax machine, a word processor, and the like.

The image forming apparatus is disposed with a developing cartridge that develops an electrostatic latent image on a photosensitive drum using a developer. The developing cartridge has a developing roller rotatably supported in its casing and performs a developing process by supplying toner stored in the casing from the developing roller to the photosensitive drum.

During the operating process of the image-forming apparatus, the developing roller and the photosensitive drum need to be tightly abutted against with each other. When the image-forming apparatus is not operating, the developing roller and photosensitive drum need to be separated by a certain distance, which may avoid problems including the photosensitive drum's contamination by excess developer attached to the developing roller caused by long-term contact between the developing roller and the photosensitive drum, deformation of the developing roller, wear and tear of the photosensitive drum, and the like.

Based on the considerations of image quality and the lifespans of the developing roller and the photosensitive drum, there is a need to develop a new developing cartridge that the developing roller and the photosensitive drum are separated from each other when the image-forming apparatus is not operating and are in contact with each other when the image-forming apparatus is operating.

### SUMMARY

One aspect of the present disclosure provides a developing cartridge. The developing cartridge includes:
a developing roller, having a rotation axis;
a developing frame, configured to support the developing roller, where the developing frame includes a cartridge body, a driving-end cover and a conductive-end cover; and the driving-end cover is at an end of the cartridge body along a length direction of the cartridge body, and the conductive-end cover is at another end of the cartridge body along the length direction of the cartridge body;
a separation contact part, connected to the conductive-end cover, where the separation contact part is capable of rotating relative to the conductive-end cover;
a tension spring, connected to the conductive-end cover and the separation contact part, where when the separation contact part rotates relative to the conductive-end cover, the tension spring is stretched;
a force-receiving part, at an end of the cartridge body along the length direction of the cartridge body and disposed at a same end as the driving-end cover, where the force-receiving part is configured to receive and transmit a driving force to rotate the developing roller; and
an electrode assembly, where the electrode assembly is at an inner side of the conductive-end cover and electrically connected to an end of the developing roller; and an opening is formed on the conductive-end cover, and a portion of the electrode assembly is exposed through the opening.

Optionally, the developing cartridge further includes another separation contact part and another tension spring, where the developing frame further includes a driving-end bearing; the driving-end bearing is disposed between the cartridge body and the driving-end cover along the length direction of the cartridge body; the another separation contact part is rotatably connected to the driving-end bearing, and the another tension spring is connected to the driving-end bearing and the another separation contact part; and when the another separation contact rotates relative to the driving-end bearing, the another tension spring is stretched.

Optionally, the developing cartridge further includes a developing-roller gear and a stirring-rack gear, where the force-receiving part, the developing-roller gear and the stirring-rack gear are disposed on an outer side of the driving-end bearing; the force-receiving part is capable of directly or indirectly being meshed with the developing-roller gear and the stirring-rack gear to transmit the driving force; and when viewed along the rotation axis direction of the developing roller, the another tension spring is disposed to be not overlapped with the stirring-rack gear.

Optionally, an end of the separation contact part is a connecting portion, and another end of the separation contact part is a matching portion; the connecting portion is connected to a supporting column on an inner side of the conductive-end cover; the matching portion is exposed from the conductive-end cover; and when the separation contact part rotates relative to the conductive-end cover, the matching portion moves toward a direction adjacent to the developing roller.

Optionally, the separation contact part is disposed with a first connecting block, and the conductive-end cover is disposed with a second connecting block; and an end of the tension spring is connected to the first connecting block, and another end of the tension spring is connected to the second connecting block.

Optionally, the separation contact part further includes a rod portion connected to the connecting portion and the matching portion; a limiting portion is further disposed on the inner side of the conductive-end cover; and the limiting portion is capable of being in contact with the rod portion of the separation contact part and located below the supporting column.

Optionally, when the tension spring is not stretched to be deformed, the limiting portion is in contact with the rod portion of the separation contact part to limit movement of the separation contact part along a direction away from the developing roller.

Optionally, the developing cartridge further includes a guarding plate at a lower edge of the driving-end cover, where along a height direction of the developing cartridge, the mating portion of the separation contact part does not protrude downward from the guarding plate.

Optionally, the developing cartridge further includes a stirring rack and a stirring-rack gear, where the stirring rack is rotatably disposed in the cartridge body; the stirring-rack gear is disposed between the driving-end cover and the cartridge body along the length direction of the cartridge body; and the stirring-rack gear rotates the stirring rack by receiving the driving force from the force-receiving part.

Optionally, the developing cartridge further includes a developing-roller gear, where the force-receiving part includes a coupling and a gear portion; the developing frame further includes a driving-end bearing; the driving-end bearing is disposed between the cartridge body and the driving-end cover along the length direction of the cartridge body; and the developing-roller gear, the gear portion and the stirring-rack gear are all disposed at an outer side of the driving-end bearing and between the driving-end bearing and the driving-end cover.

Optionally, the developing cartridge further includes another separation contact part and another tension spring, where the another separation contact part is rotatably connected to the driving-end bearing; two ends of the another tension spring are respectively connected to the driving-end bearing and the another separation contact part; when another separation contact part rotates relative to the driving-end bearing, the another tension spring is stretched; and when viewed along the rotation axis direction of the developing roller, the another tension spring is disposed to be not overlapped with the stirring-rack gear.

Optionally, an end of the another separation contact part is disposed with a matching portion; the mating portion makes the another separation contact part to rotate relative to the driving-end bearing under action of an external force; and along a height direction of the developing cartridge, the matching portion protrudes downward from the cartridge body, the stirring-rack gear is on the another tension spring, and the another tension spring is on the matching portion.

Another aspect of the present disclosure provides a developing cartridge. The developing cartridge includes:
a developing roller, having a rotation axis;
a developing frame, configured to support the developing roller, where the developing frame includes a cartridge body, a driving-end cover and a conductive-end cover; and the driving-end cover is at an end of the cartridge body along a length direction of the cartridge body, and the conductive-end cover is at another end of the cartridge body along the length direction of the cartridge body;
a first separation contact part, connected to the conductive-end cover, where the first separation contact part is capable of rotating between a first position and a second position relative to the conductive-end cover;
a first tension spring, connected to the conductive-end cover and the first separation contact part, where when the first separation contact part rotates from the first position to the second position relative to the conductive end cover, the first tension spring is stretched;
a force-receiving part, at an end of the cartridge body along the length direction of the cartridge body and disposed at a same end as the driving-end cover, where the force-receiving part is configured to receive and transmit a driving force to rotate the developing roller; and
a conductive part, where the conductive part is at an inner side of the conductive-end cover and electrically connected to an end of the developing roller; and an opening is formed on the conductive-end cover, and a portion of the conductive part is exposed through the opening.

Optionally, when an external force does not act on the first separation contact part, the first separation contact part is in the first position, and the first tension spring is not stretched; and when the external force acts on the first separation contact part, the first separation contact part is capable of rotating from the first position to the second position under action of the external force, and the first tension spring is stretched to be deformed.

Optionally, a matching portion is disposed at an end of the first separation contact part; the matching portion protrudes downward from the cartridge body along a height direction of the developing cartridge; and when the first separation contact part rotates from the first position to the second position, the matching portion moves toward a direction adjacent to the developing roller.

Optionally, the developing cartridge further includes a stirring-rack gear, a second separation contact part and a second tension spring, where the developing frame further includes a driving-end bearing; the second separation contact part is rotatably connected to the driving-end bearing; an end of the second tension spring is connected to the second separation contact part, and another end of the second tension spring is connected to the drive-end bearing; the driving-end bearing is disposed between the cartridge body and the driving-end cover along the length direction of the cartridge body; the stirring-rack gear, the second separation contact part and the second tension spring are disposed at an outer side of the driving-end bearing; and when viewed along the rotation axis direction of the developing roller, a portion of the second separation contact part protrudes from the cartridge body, and the second tension spring is not overlapped with the stirring-rack gear.

Another aspect of the present disclosure provides a developing cartridge. The developing cartridge includes:
a developing roller, having a rotation axis;
a developing frame, configured to support the developing roller, where the developing frame includes a cartridge body, a driving-end cover, a conductive-end cover, and a driving-end bearing; the driving-end bearing at an end of the cartridge body along a length direction of the cartridge body, and the conductive-end cover is at another end of the cartridge body along the length direction of the cartridge body; and the driving-end cover is disposed at an outer side of the drive-end bearing;
a first swing rod, connected to the conductive-end cover, where the first swing rod is capable of rotating between a first position and a second position relative to the conductive-end cover;
a second swing rod, connected to the drive-end bearing, where the second swing rod is capable of rotating between the first position and the second position relative to the driving-end bearing;
a first tension spring, connected to the conductive-end cover and the first swing rod, where when the first swing rod rotates from the first position to the second position relative to the conductive-end cover, the first tension spring is stretched to be deformed;
a second tension spring, connected to the driving-end bearing and the second swing rod, where when the second swing rod rotates from the first position to the second position relative to the driving-end bearing, the second tension spring is stretched to be deformed;
a force-receiving part, disposed on the driving-end bearing, where the force-receiving part is configured to receive and transmit a driving force to rotate the developing roller; and
a conductive part, where the conductive part is at an inner side of the conductive-end cover and electrically connected to an end of the developing roller; and an opening is formed on the conductive-end cover, and a portion of the conductive part is exposed through the opening.

Optionally, the developing cartridge further includes a developing-roller gear, a stirring rack and a stirring-rack gear, where the stirring rack is rotatably disposed in the cartridge body; the developing-roller gear and the stirring-rack gear are disposed at an outer side of the driving-end bearing; and the force-receiving part is capable of directly or indirectly being meshed with the developing-roller gear and the stirring-rack gear to transmit the driving force to the developing roller and the stirring rack, thereby rotating the developing roller and the stirring rack.

Another aspect of the present disclosure provides a developing cartridge. The developing cartridge includes:
a developing roller, having a rotation axis;
a developing frame, configured to support the developing roller, where the developing frame includes a cartridge body, a driving-end cover, a conductive-end cover, and a driving-end bearing; the driving-end bearing at an end of the cartridge body along a length direction of the cartridge body, and the conductive-end cover is at another end of the cartridge body along the length direction of the cartridge body; and the driving-end cover is disposed at an outer side of the drive-end bearing;
a first separation contact part, connected to the conductive-end cover, where the first separation contact part is capable of rotating relative to the conductive-end cover;
a second separation contact part, connected to the driving-end bearing, where the second separation contact part is capable of rotating relative to the driving-end bearing;
a first tension spring, connected to the conductive-end cover and the first separation contact part, where when the first separation contact part rotates relative to the conductive-end cover, the first tension spring is stretched to be deformed;
a second tension spring, connected to the driving-end bearing and the second separation contact part, where when the second separation contact part rotates relative to the driving-end bearing, the second tension spring is stretched to be deformed;
a force-receiving part, at an end of the developing frame along the length direction of the cartridge body and disposed at a same end as the driving-end cover, where the force-receiving part is configured to receive and transmit a driving force to rotate the developing roller; and
a conductive part, where the conductive part is at an inner side of the conductive-end cover and electrically connected to an end of the developing roller; and an opening is formed on the conductive-end cover, and a portion of the conductive part is exposed through the opening.

Optionally, a matching portion is disposed at each of an end of the first separation contact part and an end of the second separation contact part; along a height direction of the developing cartridge, the mating portion of the first separation contact part is exposed from the conductive-end cover, and the mating portion of the second separation contact part protrudes downward from the cartridge body; and when the first separation contact part rotates relative to the conductive-end cover, the matching portion of the first separation contact part moves toward a direction adjacent to the developing roller.

Other aspects of the present disclosure may be understood by those skilled in the art in light of the description, the claims, and the drawings of the present disclosure.

Compared with the existing technology, the technical solutions provided by the present disclosure may achieve at least following beneficial effects.

In the developing cartridge of the present disclosure, the assemblies for the developing cartridge to be in contact with and separated from the photosensitive drum may have simple structures, which may be convenient for installation and save costs.

### BRIEF DESCRIPTION OF THE DRAWINGS

FIG. 1 illustrates an exploded schematic of a driving end of a developing cartridge in the exiting technology.

FIG. 2 illustrates an exploded schematic of a conductive end of a developing cartridge in the exiting technology.

FIG. 3 illustrates an internal structural schematic of an image-forming apparatus in the exiting technology.

FIG. 4 illustrates a schematic of a separation assembly when a developing roller is in contact with a photosensitive drum in the exiting technology.

FIG. 5 illustrates a schematic of a separation assembly when a developing roller is separated with a photosensitive drum in the exiting technology.

FIG. 6 illustrates a structural schematic of a developing cartridge from an angle according to exemplary embodiment one of the present disclosure.

FIG. 7 illustrates a structural schematic of a developing cartridge from another angle according to exemplary embodiment one of the present disclosure.

FIG. 8 illustrates an exploded structural schematic of a driving end of a developing cartridge according to exemplary embodiment one of the present disclosure.

FIG. 9 illustrates an exploded structural schematic of a conductive end of a developing cartridge according to exemplary embodiment one of the present disclosure.

FIG. 10 illustrates a structural schematic of a conductive-end bearing and a separation assembly of a developing cartridge according to exemplary embodiment one of the present disclosure.

FIG. 11 illustrates a structural schematic of a conductive-end bearing and a separation contact part of a developing cartridge according to modification of exemplary embodiment one of the present disclosure.

FIG. 12 illustrates a structural schematic of a conductive-end bearing and a separation assembly of a developing cartridge from an angle according to exemplary embodiment two of the present disclosure.

FIG. 13 illustrates a structural schematic of a conductive-end bearing and a separation assembly of a developing cartridge from another angle according to exemplary embodiment two of the present disclosure.

FIG. 14 illustrates a structural schematic of a conductive-end bearing and a separation contact part of a developing cartridge according to modification of exemplary embodiment two of the present disclosure.

FIG. 15 illustrates a structural schematic of a conductive-end bearing and a separation contact part of a developing cartridge according to exemplary embodiment three of the present disclosure.

FIG. 16 illustrates a structural schematic of a conductive-end bearing and a separation contact part of a developing cartridge according to exemplary embodiment four of the present disclosure.

FIG. 17 illustrates a structural schematic of a conductive-end bearing and a separation contact part of a developing cartridge according to modification of exemplary embodiment four of the present disclosure.

FIG. 18 illustrates a structural schematic of a conductive-end bearing and a separation assembly of a developing cartridge according to exemplary embodiment five of the present disclosure.

FIG. 19 illustrates a structural schematic of a conductive-end bearing and a separation assembly of a developing cartridge according to exemplary embodiment five of the present disclosure.

FIG. 20 illustrates a structural schematic of a developing cartridge according to exemplary embodiment five of the present disclosure.

FIG. 21 illustrates a structural schematic of a conductive-end bearing and a separation assembly of a developing cartridge according to exemplary embodiment six of the present disclosure.

FIG. 22 illustrates an exploded structural schematic of a driving end of a developing cartridge according to exemplary embodiment six of the present disclosure.

FIG. 23 illustrates a partial cross-sectional view of a driving end of a developing cartridge according to exemplary embodiment six of the present disclosure.

FIG. 24 illustrates a structural schematic of a driving end of a developing cartridge according to exemplary embodiment seven of the present disclosure (a driving-end cover is omitted).

FIG. 25 illustrates an enlarged schematic of a region A in FIG. 24.

FIG. 26 illustrates a partial structural schematic of a developing cartridge according to exemplary embodiment seven of the present disclosure.

FIG. 27 illustrates a structural schematic of a developing cartridge after removing a force-transmission part according to exemplary embodiment seven of the present disclosure.

FIG. 28 illustrates a matching schematic of a separation assembly and a driving end pressing part of a developing cartridge according to exemplary embodiment seven of the present disclosure.

FIG. 29 illustrates a structural schematic of a developing cartridge according to exemplary embodiment eight of the present disclosure (a driving-end cover is omitted).

FIG. 30 illustrates a partial structural schematic of a developing cartridge according to exemplary embodiment nine of the present disclosure.

FIG. 31 illustrates an overall structural schematic of a developing cartridge according to exemplary embodiment ten of the present disclosure.

FIG. 32 illustrates a structural schematic of a developing cartridge according to exemplary embodiment ten of the present disclosure (a driving-end cover is omitted).

FIG. 33 illustrates a structural schematic of matching a driving-end cover and an assembly to-be-detected from an angle according to exemplary embodiment ten of the present disclosure.

FIG. 34 illustrates a structural schematic of matching a driving-end cover and an assembly to-be-detected from another angle according to exemplary embodiment ten of the present disclosure.

FIG. 35 illustrates a structural schematic of a driving-end cover according to exemplary embodiment ten of the present disclosure.

FIG. 36 illustrates a structural schematic of a part to-be-detected from an angle according to exemplary embodiment ten of the present disclosure.

FIG. 37 illustrates a structural schematic of a part to-be-detected from another angle according to exemplary embodiment ten of the present disclosure.

FIG. 38 illustrates a structural schematic of a rotating part according to exemplary embodiment ten of the present disclosure.

### DETAILED DESCRIPTION

The present disclosure is further described in detail below with reference to the accompanying drawings. Obviously, described embodiments are a part of embodiments of the present disclosure, rather than all embodiments of the present disclosure. Based on embodiments of the present disclosure, all other embodiments obtained by those skilled in the art without making creative efforts fall within the protection scope of the present disclosure.

It should be noted that the terms “first”, “second” and the like are only used for descriptive purposes and cannot be understood as indicating or implying relative importance or implicitly indicating the number of indicated technical features. Therefore, features defined with “first” and “second” may explicitly or implicitly include at least one of these features. In the description of the present disclosure, “a plurality of” means at least two, such as two, three or the like, unless otherwise expressly and specifically limited.

In the present disclosure, unless otherwise expressly and specifically defined and limited, the terms “installation”, “connection”, “fixation” and other terms should be understood in a broad sense. For example, the connection may be a fixed connection, a detachable connection, or a single piece; may be a mechanical connection, an electrical connection, or a communication with each other; may be a direct connection or an indirect connection through an intermediate medium; or may be an internal connection between two elements or an interactive relationship between two elements, unless otherwise explicitly limited. For those skilled in the art, specific meanings of above-mentioned terms in the present disclosure may be understood according to specific circumstances.

In the present disclosure, unless otherwise expressly and specifically defined and limited, the first feature being “on” or “below” the second feature may be that the first feature is in direct contact with the second features, or the first feature is in indirect contact with the second features through an intermediate medium. Furthermore, the first feature being “above”, “at upper side” and “on” the second feature may be that the first feature is directly above or diagonally above the second feature, or simply indicates that the height of the first feature is higher than the height of the second feature. The first feature being “below”, “at lower side” and “beneath” the second feature may be that the first feature is directly below or diagonally below the second feature, or simply indicates that the height of the first feature is lower than the height of the second feature.

In the present disclosure, description of reference terms including “one embodiment”, “some embodiments”, “examples”, “specific examples”, or “some examples” and the like may indicate that specific features, structures, materials and/or characteristics described in embodiment(s) or example(s) are included in at least one embodiment or example of the present disclosure. In the present disclosure, descriptive expressions of above-mentioned terms are not necessarily directed to same embodiment or example. Furthermore, specific features, structures, materials and/or characteristics described may be combined in any suitable manner in any one or more embodiments or examples. In addition, those skilled in the art may combine and arrange different embodiments or examples, and also combine and arrange features of different embodiments or examples described in the present disclosure unless being inconsistent with each other.

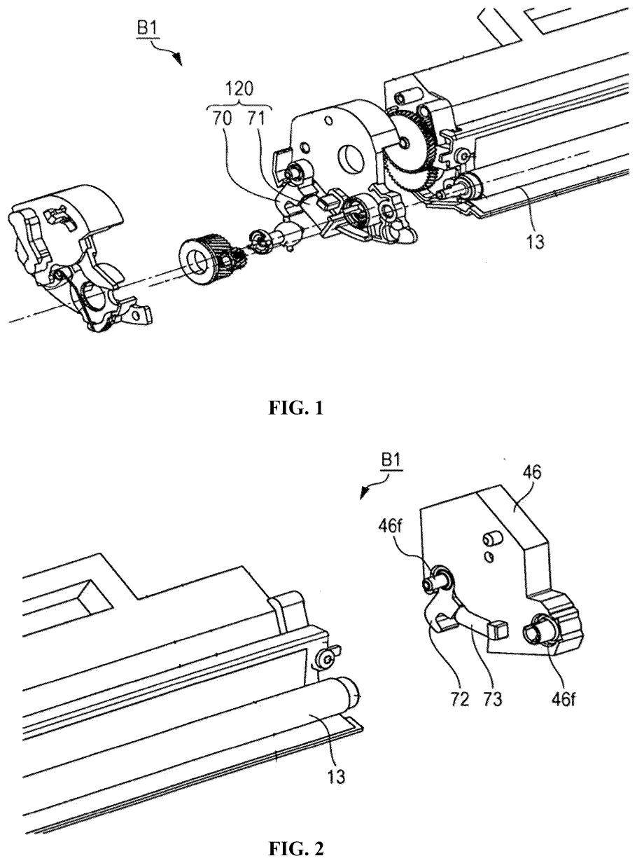

As shown in FIGS. 1-2, in an existing developing cartridge B1, along a length direction of the developing cartridge B1, one end of the developing cartridge B1 is a driving end, and another end of the developing cartridge B1 is a conductive end; and a separation assembly of the conductive end includes a swing rod 72 and a spring 73, where one end of the spring 73 is abutted against the swing rod 72, and another end of the spring 73 is abutted against a bearing 46. The swing rod 72 is movably connected to the bearing 46. When the bearing 46 is fixedly installed on the developing cartridge B1, the swing rod 72 rotates around a fixed axle 46f upon receiving force and exerts a force on the spring 73, such that the spring 73 drives the developing cartridge B1 to rotate together. A separation assembly 120 of the driving end includes a swing rod 70 and a spring 71. The connection relationship of the swing rod 70 and the spring 71 of the driving end is similar to the connection relationship of the swing rod 72 and the spring 73 of the conductive end.

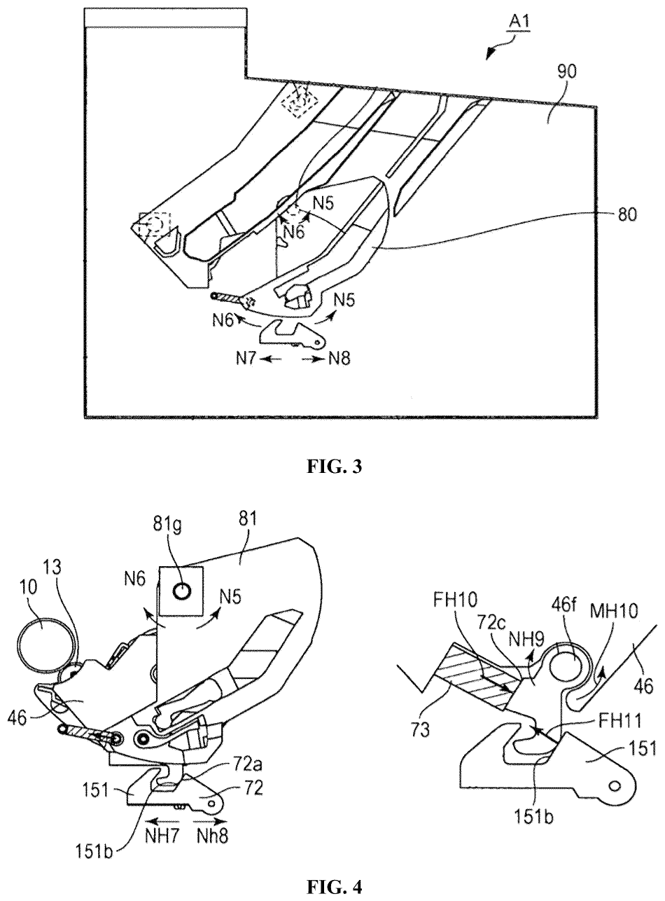

As shown in FIGS. 3-4, an existing image-forming apparatus A1 is disposed with a swing-guiding part 80, where the swing-guiding part 80 is disposed with a sliding groove that may be matched with positioning columns at two ends of the developing cartridge B1. In addition, the swing-guiding part 80 is supported by a side plate 90 and may rotate along the direction of an arrow N5 and the direction of an arrow N6.

Moreover, the image-forming apparatus A1 is further disposed with a driving-end pressing part 150. The driving-end pressing part 150 is supported by a base plate (not shown) and may move along the direction of an arrow N7 and the direction of an arrow N8, such that the surface of the photosensitive drum 10 is in contact with and separated from the developing roller 13. The image-forming apparatus is also disposed with a conductive-end pressing part 151 and a conductive-end swing-guiding part 81.

As shown in FIG. 4, the second contact surface 151b of the conductive-end pressing part 151 is in contact with the first contact surface 72a of the swing rod 72, and the swing rod 72 rotates along the direction of an arrow NH9 against the bias force of the spring 73. Subsequently, the third contact surface 72c of the swing rod 72 compresses the spring 73 and receives a bias force FH10. At this point, the swing rod 72 is also subjected to the force FH11 of the swing-guiding part 151, such that the torque balanced with the torque MH10 exerts on the swing rod 70. Therefore, the force FH11 exerts on the developing cartridge B1. The developing cartridge rotates after receiving force, such that the developing roller 13 is in contact with the photosensitive drum 10.

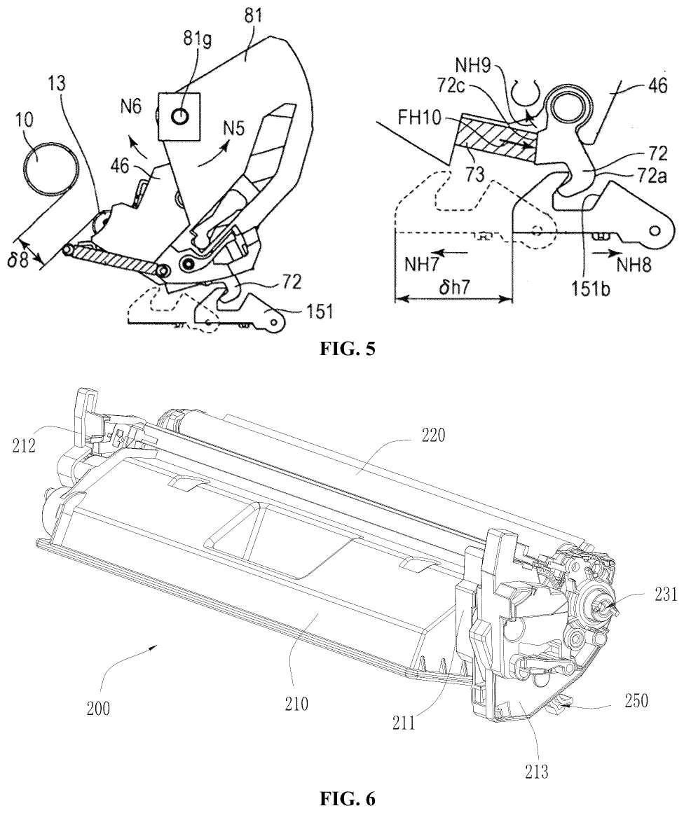

As shown in FIG. 5, the conductive-end pressing part 151 moves a distance δh7 along the direction of an arrow NH8. Therefore, the developing cartridge B1 rotates along the direction of an arrow N5 using a supported protruding portion 81g of the swing-guiding part 81 as the center; and the developing roller 13 and the photosensitive drum 10 are spaced apart from each other by a distance δ8.

Based on the considerations of image quality and the lifespans of the developing roller and the photosensitive drum, there is a need to develop a new developing cartridge that the developing roller and the photosensitive drum are separated from each other when the image-forming apparatus is not operating and are in contact with each other when the image-forming apparatus is operating.

### Exemplary Embodiment One

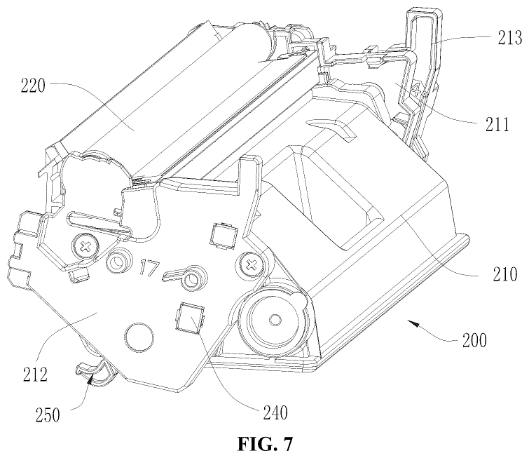

As shown in FIGS. 6-7, a developing cartridge 200 is provided in one embodiment. The developing cartridge 200 may include a developing frame, a developing roller 220, a stirring rack (not shown), a driving assembly, an electrode assembly 240, and a separation assembly.

As shown in FIGS. 6-7, the developing frame may include a cartridge body 210, a driving-end bearing 211, a conductive-end cover 212 and a driving-end cover 213. The driving-end cover may include a first part at a lower edge of the driving-end cover; and also include a second part which is a part of the driving-end cover different from the first part. The first part may include a plate-shaped part. Along the length direction, one end of the developing frame may be the driving end, and the other end of the developing frame may be the conductive end. A toner bin, which accommodates a developer, may be inside the cartridge body 210; and the developer may be carbon toner. The driving-end bearing 211 may be disposed on the end surface of the driving end of the cartridge body 210, and the driving-end cover 213 may be disposed on the outside of the driving-end bearing 211. That is, the driving-end cover 213 may be further away from the cartridge body 210 than the driving-end bearing 211. The conductive-end cover 212 may be disposed on the end surface of the conductive end of the cartridge body 210. That is, the conductive-end cover 212 and the driving-end cover 213 may be respectively located outside two ends of the cartridge body 210 along the length direction.

As shown in FIGS. 6-7, the developing roller 220 may be rotatably supported on the developing frame. For example, the length direction of the developing roller 220 may be consistent with the length direction of the developing frame, and the rotation axis of the developing roller 220 may extend along the length direction of the developing roller 220. Both ends of the developing roller 220 may be supported at the driving-end bearing 211 and the conductive-end cover 212, respectively.

The stirring rack may be rotatably supported on the developing frame and be located in the toner bin of the cartridge body 210. For example, both ends of the stirring rack may be supported on the driving-end bearing 211 and the conductive-end cover 212; and the length direction of the stirring rack may be consistent with the length direction of the developing frame. The stirring rack may rotate circumferentially along its axis in the length direction. The stirring rack may have one or more blades. The blades may be rotated to stir the developer in the toner bin to prevent the developer in the toner bin from aggregation and transport the developer toward the developing roller 220 to be adsorbed by the charged developing roller 220.

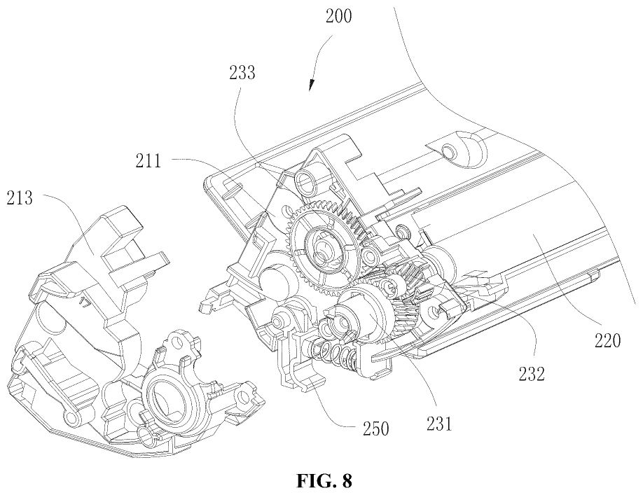

As shown in FIGS. 6 and 8, the driving assembly may be disposed outside the driving-end bearing 211 (the side facing away from the cartridge body 210) and include a force-receiving part 231 and a gear set. The force-receiving part 231 may be configured to receive the driving force of the image-forming apparatus A1 and transmit the driving force through the gear set, thereby driving the developing roller 220 and the stirring rack to rotate. The gear set may include the developing-roller gear 232 and the stirring-rack gear 233. The developing-roller gear 232 may be fixed to one end of the axle of the developing roller 220 along the length direction and may be located outside the driving-end bearing 211. The developing-roller gear 232 may be meshed with the force-receiving part 231, such that the developing roller 220 may receive the driving force to rotate. The mixing rack gear 233 may be fixed on one end of the mixing rack along the length direction and may be located outside the driving bearing. The stirring-rack gear 233 may be meshed with the force-receiving part 231, such that the stirring rack may receive the driving force to rotate. Both the developing-roller gear 232 and the stirring-rack gear 233 may directly or indirectly mesh with the force-receiving part 231.

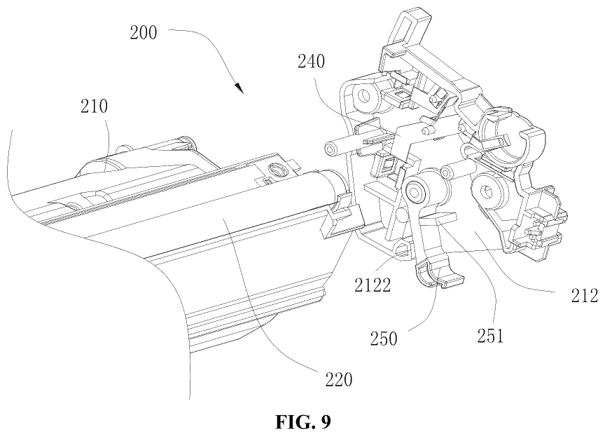

As shown in FIGS. 7 and 9, the electrode assembly 240 may be disposed at the conductive end of the developing frame and located inside the conductive-end cover 212. An opening may be formed at the conductive-end cover 212. At least a portion of the electrode assembly 240 may be exposed from the opening to be electrically connected to the image-forming apparatus A1. The electrode assembly 240 may be also electrically connected to the other end of the developing roller 220 along the length direction, thereby charging the developing roller 220 which may be capable of adsorbing the developer.

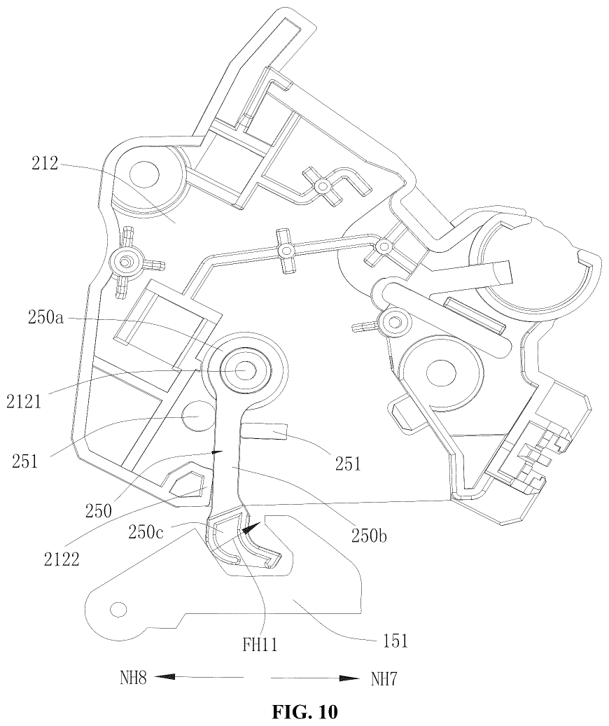

As shown in FIGS. 9-10, the separation assembly may receive the force of the image-forming apparatus A1 and drive the developing cartridge 200 to move close to (adjacent to) or away from the photosensitive drum, such that the developing roller 220 may be in contact with or separated from the photosensitive drum. The separation assembly may be disposed at the driving end of the developing frame or may be disposed at the conductive end of the developing frame or may be disposed at both the driving end and the conductive end of the developing frame.

In one embodiment, the separation assembly may include a separation contact part 250. The separation contact part 250 may be disposed on the developing frame and may receive the force of the image-forming apparatus A1 to elastically deform between the first position and the second position. The separation contact part 250 in one embodiment may be equivalent to the swing rod 72 in the existing technology.

For example, as shown in FIGS. 9-10, the separation contact part 250 may include a connecting portion 250a, a rod portion 250b and a matching portion 250c that are connected in sequence. That is, the connecting portion 250a may be one end of the separation contact part 250, and the matching portion 250c may be the other end of the separation contact part 250. The connecting portion 250a may be configured to assemble the separation contact part 250 on the developing frame, and the matching portion 250c may be configured to receive the force of the image-forming apparatus A1.

As shown in FIGS. 9-10, taking the separation contact part 250 disposed at the conductive end of the developing frame as an example, a supporting column 2121 may be disposed inside the conductive-end cover 212; the supporting column 2121 may protrude from the inner side of the conductive-end cover 212; and the separation contact part 250 may be detachably connected to the supporting column 2121. For example, a through hole may be formed at the connecting portion 250a. The connecting portion 250a may be sleeved on the supporting column 2121 through the through hole. In such way, the separation contact part 250 may be assembled on the conductive-end cover 212 and may rotate around the supporting column 2121. The length direction of the rod portion 250b may extend along the direction intersecting the length direction of the developing frame. One end of the rod portion 250b may extend to a position adjacent to the edge of the conductive-end cover 212, and the matching portion 250c may be disposed at the end of the rod portion 250b to be exposed from the conductive-end cover 212, which may facilitate matching with the conductive-end pressing part 151 of the image-forming apparatus A1 to receive the force.

In some other embodiments, the connecting portion 250a may also be pasted, welded, or clipped and fixed on the conductive-end cover 212.

Furthermore, as shown in FIGS. 9-10, the first protrusion 251 may be also formed at the inner side of the conductive-end cover 212; the first protrusion 251 may be disposed adjacent to the supporting column 2121 and located below the supporting column 2121; the number of the first protrusions 251 may be two; and two first protrusions 251 may be clamped on two sides of the separation contact part 250.

Furthermore, as shown in FIGS. 9-10, the separation contact part 250 may be made of an elastic material and may produce elastic deformation. A limiting portion 2122 may be also disposed at the inner side of the conductive-end cover 212. The limiting portion 2122 may be located on the side of the separation contact part 250 away from the developing roller 220 and may restrict the separation contact part 250, which may limit movement of the separation contact part 250 along the direction away from the developing roller 220. Without external force, the separation contact part 250 may be located in the position in contact with the limiting portion 2122, and the separation contact part 250 may not deform. At this point, the position of the separation contact part 250 may be the first position, and the second position may be a position closer to the developing roller 220 (or closer to the photosensitive drum) than the first position.

When the separation contact part 250 is in the first position, the developing cartridge 200 may be located at the position away from the photosensitive drum, and the developing roller 220 may be separated from the photosensitive drum. When the separation contact part 250 moves from the first position to the second position, the developing roller 220 may come into contact with the photosensitive drum.

As shown in FIGS. 4, 9 and 10, when the image-forming apparatus A1 is operating (when the printing task is in progress), the conductive-end pressing part 151 in the image-forming apparatus A1 may move along the NH7 direction to be abutted against the matching portion 250c of the separation contact part 250 and exert the force FH11 (push force) to the separation contact part 250. The portion of the separation contact part 250 below the first protrusion 251 may be deformed from the first position to the second position. Simultaneously, the force FH11 of the conductive-end pressing part 151 may also exert on the developing cartridge 200. The developing cartridge 200 may rotate along the direction adjacent to the photosensitive drum after receiving force, such that the developing roller 220 may be in contact with the photosensitive drum. The deformation of the separation contact part 250 may generate a bias force on the conductive-end pressing part 151, and the conductive-end pressing part 151 may also generate a reaction force along the opposite direction to the bias force. The reaction force may be exerted on the developing cartridge 200, which may make the developing roller 220 to further closer to the photosensitive drum. The bias force generated by the deformation of the separation contact part 250 may also play a cushioning role, which may allow desirable contact between the developing roller 220 and the photosensitive drum to ensure developing quality.

As shown in FIGS. 5, 9 and 10, when the image-forming apparatus A1 ends printing, the conductive-end pressing part 151 in the image-forming apparatus A1 may move along the NH8 direction, and the conductive-end pressing part 151 may be abutted against the matching portion 250c of the separation contact part 250 to exert force on the matching portion 250c. In such way, entire developing cartridge 200 may rotate along the direction away from the photosensitive drum (the direction N5 in FIG. 5), such that the developing roller 220 and the photosensitive drum may be spaced apart from each other by a distance δ8. Simultaneously, the separation contact part 250 may restore elastic deformation, which may deform from the second position to the first position; and may no longer deform away from the developing roller 220 after being in contact with the limiting portion 2122.

It should be noted that above-mentioned separation assembly may be not limited to being disposed at the conductive end, but may also be disposed at the driving end, and may also be disposed at the driving end and the conductive end. When disposed at the driving end, the separation contact part 250 may be disposed at the outer side of the driving-end bearing 211; the supporting column 2121, the first protrusion 251, the limiting portion 2122 and other structures may be disposed at the outer side of the driving-end bearing 211; and the connection manner may be same as the connection manner when the separation assembly is located at the conductive end, which may not be described in detail herein.

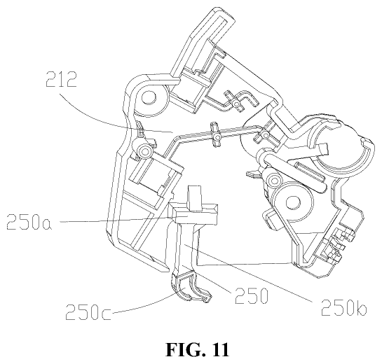

In a modification of exemplary embodiment one, as shown in FIG. 11, the separation assembly may also be integrally formed with the conductive-end cover 212, and the first protrusion 251 may be omitted. Optionally, entire separation assembly and the conductive-end cover 212 may be made of a POM (polyoxymethylene) material. For example, the separation assembly may be the separation contact part 250. The separation contact part 250 may include the connecting portion 250a, the rod portion 250b and the matching portion 250c which are connected in sequence. That is, the connecting portion 250a may be one end of the separation contact part 250, and the matching portion 250c may be the other end of the separation contact part 250. The connecting portion 250a may be configured to assemble the separation contact part 250 on the developing frame, and the matching portion 250c may be configured to receive the force of the image-forming apparatus A1. The operating process of such separation assembly may be consistent with above-mentioned separation assembly. When the image-forming apparatus A1 is operating, the separation contact part 250 may elastically deform itself after receiving the force of the conductive-end pressing part 151 of the image-forming apparatus A. In such way, the developing cartridge 200 may rotate along the direction adjacent to the photosensitive drum after receiving force, such that the developing roller 220 may come into contact with the photosensitive drum. When the image-forming apparatus A1 finishes printing, the separation contact part 250 may receive the force from the conductive-end pressing part 151, such that the developing roller 220 and the photosensitive drum may be separated by a certain distance to achieve separation of the developing roller 220 and the photosensitive drum.

The separation assembly of one embodiment may be a simple structure. By eliminating the spring structure as in the existing technology, the separation assembly may also achieve same separation effect, thereby simplifying the structure and making installation simple to save costs.

### Exemplary Embodiment Two

Another developing cartridge 200 is provided in one embodiment. Compared with exemplary embodiment one, the difference may be the structure of the separation assembly.

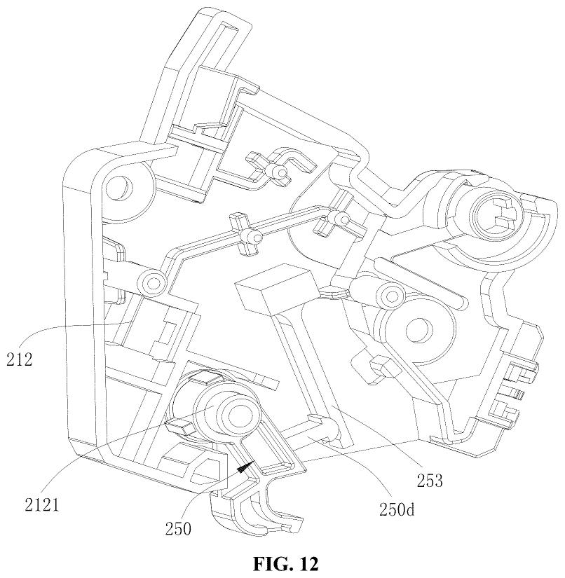

In one embodiment, as shown in FIG. 12, the separation assembly may include the separation contact part 250 and a first blocking plate 253. The first protrusion 251 in exemplary embodiment one may be eliminated. The separation contact part 250 in one embodiment may be not made of an elastic material and cannot elastically deform itself. Other structures of the separation contact part 250 may be same as the structures in exemplary embodiment one.

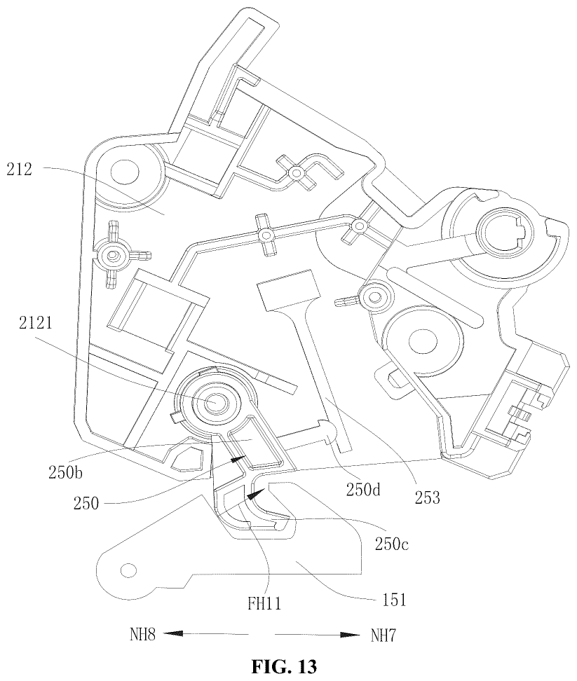

As shown in FIGS. 12-13, the separation contact part 250 may be rotatably disposed at the conductive-end cover 212 and may receive the force of the image-forming apparatus A1 to move between the first position and the second position. That is, the separation contact part 250 may rotate using the supporting column 2121 as the center. The separation contact part 250 may be disposed with the second protrusion 250d. The second protrusion 250d may be disposed at the rod portion 250b of the separation contact part 250 and located on the side of the separation contact part 250 facing the developing roller 220.

As shown in FIGS. 12-13, the first blocking plate 253 may be disposed on the inner side of the conductive-end cover 212. The first blocking plate 253 may be on the side of the separation contact part 250 facing the developing roller 220. At least a part of the first blocking plate 253 may be made of an elastic material, and such part of the first blocking plate 253 may elastically deform when receiving force; or entire first blocking plate 253 may also be made of an elastic material, for example, the first blocking plate 253 may be an elastic silicone plate.

When the separation contact part 250 is in the first position, the second protrusion 250d and the first blocking plate 253 may be in a non-contact state or may be in contact with each other but without interaction force.

When the separation contact part 250 receives the force of the conductive-end pressing part 151 of the image-forming apparatus A1 and rotates from the first position to the second position, the force of the conductive-end pressing part 151 may also exert on the developing cartridge 200. The developing cartridge 200 may rotate along the direction adjacent to the photosensitive drum, such that the developing roller 220 may be in contact with the photosensitive drum. Simultaneously, during the rotation of the separation contact part 250, the second protrusion 250d may be abutted against and press the first blocking plate 253, and the first blocking plate 253 may deform to generate a bias force on the separation contact part 250 along the direction that moves the separation contact part 250 from the second position to the first position. The separation contact part 250 may also generate a reaction force along the opposite direction to the bias force. The reaction force may exert on the developing cartridge 200 to make the developing roller 220 further closer to the photosensitive drum. The bias force generated by the deformation of the first blocking plate 253 may also play a cushioning role, which may allow desirable contact between the developing roller 220 and the photosensitive drum to ensure developing quality.

It should be noted that above-mentioned separation assembly may be not limited to being disposed at the conductive end, but may also be disposed at the driving end, and may also be disposed at the driving end and the conductive end.

In some embodiments, the structures of the separation assemblies of the conductive ends and the driving ends may be same or different. For example, the conductive end may be disposed with the separation assembly as in exemplary embodiment two, and the driving end may be disposed with the separation assembly as in exemplary embodiment one; and opposite arrangement of the separation assemblies may also be configured, which may not be limited herein.

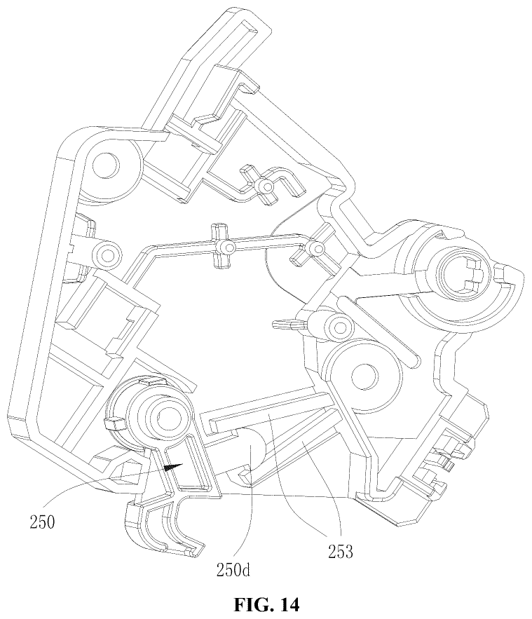

As a modification of exemplary embodiment two, as shown in FIG. 14, the number of the first blocking plates 253 may be two. The distance between two first blocking plates 253 may gradually decrease along the direction from the first position to the second position; that is, two first blocking plates 253 may be in a splayed shape. In the first position, the second protrusion 250d of the separation contact part 250 may be inserted between two first blocking plates 253; and may or may not be in contact with the first blocking plates 253. When the separation contact part 250 receives the force of the conductive-end pressing part 151 and rotates from the first position to the second position, the second protrusion 250d may press the first blocking plate 253, such that the first blocking plate 253 may elastically deform to generate a bias force on the separation contact part 250 along the direction that moves the separation contact part 250 from the second position to the first position.

Other structures of the developing cartridge 200 may be similar to the structures of exemplary embodiment one, which may not be described in detail herein.

### Exemplary Embodiment Three

A developing cartridge 200 is provided in one embodiment. Compared with exemplary embodiment one and exemplary embodiment two, the difference may be that the separation contact part 250 may be a fixed structure, and the supporting column 2121 may be eliminated.

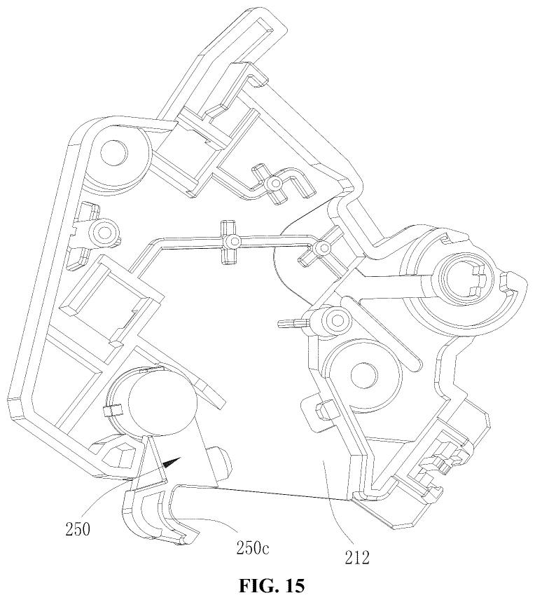

In one embodiment, as shown in FIG. 15, the separation contact part 250 may be fixedly disposed at the inner side of the conductive-end cover 212. The structure of the separation contact part 250 may be same as the structure of the separation contact part in exemplary embodiment one and embodiment two. The separation contact part 250 may be an integrally formed structure with the conductive-end cover 212, or may be a separate structure, and may be fixed on the inner side of the conductive-end cover 212 by pasting, welding, snapping or other fixing manners.

The separation contact part 250 may be in contact with the conductive-end pressing part 151 of the image-forming apparatus A1 through the matching portion 250c. Therefore, the separation contact part 250 may receive the force from the image-forming apparatus A1 and drive the developing cartridge 200 to move between the position where the developing roller 220 is in contact with the photosensitive drum and the position where the developing roller 220 is separated from the photosensitive drum.

The separation contact part 250 fixedly disposed in one embodiment may be a simple structure and may not require other structures.

The separation contact part 250 in one embodiment may be disposed at one end or two ends of the developing frame.

Other structures of the developing cartridge 200 may be similar to the structures of exemplary embodiment one, which may not be described in detail herein.

### Exemplary Embodiment Four

A developing cartridge 200 is provided in one embodiment. Compared with exemplary embodiment three, the difference may be that the separation assembly may include the separation contact part 250 and an elastic part 254a.

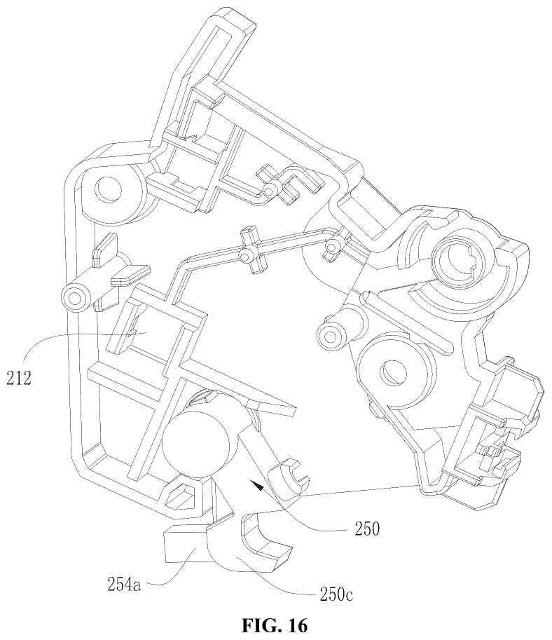

In one embodiment, as shown in FIG. 16, the separation contact part 250 may be fixedly disposed at the inner side of the conductive-end cover 212, and the elastic part 254a may be disposed on the side of the separation contact part 250 away from the photosensitive drum. For example, the elastic part 254a may be disposed on the side of the matching portion 250c of the separation contact part 250 away from the photosensitive drum; that is, the elastic part 254a may be also exposed outside the conductive-end cover 212. The elastic part 254a may be a silicone block.

When the image-forming apparatus A1 is operating, the conductive-end pressing part 151 of the image-forming apparatus A1 may be in contact with one end of the elastic part 254a, thereby exerting the force on the elastic part 254a. Such force may also exert on the separation contact part 250 and entire developing cartridge 200 to drive the developing cartridge 200 to move from the position where the developing roller 220 is separated from the photosensitive drum to the position where the developing roller 220 is in contact with the photosensitive drum. Simultaneously, the elastic part 254a may be pressed to be deformed, which may generate a pressing force on the separation contact part 250 and play a cushioning role, such that the developing roller 220 may be in desirable contact with the photosensitive drum.

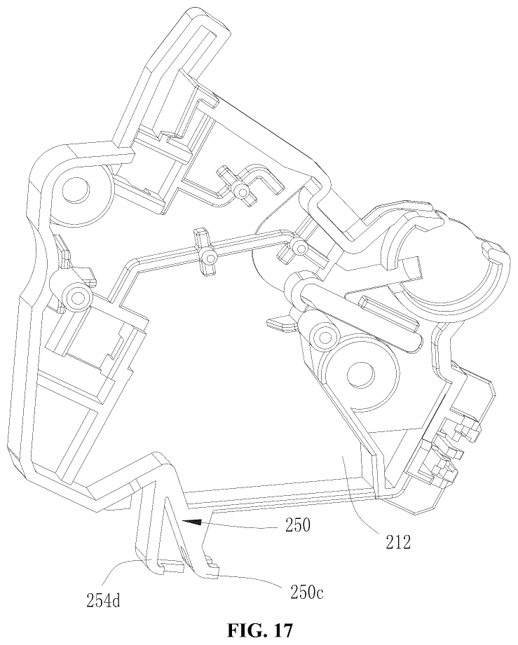

As a modification of exemplary embodiment four, as shown in FIG. 17, the elastic part may be an elastic part 254d. One end of the elastic part 254d may be connected to the separation contact part 250, and the other end of the elastic part 254d may extend to the side of the matching portion 250c away from the photosensitive drum. In addition, the other end of the elastic part 254d may be not in contact with the matching portion 250c; that is, a gap may be between the elastic part 254d and the matching portion 250c of the separation contact part 250.

When the image-forming apparatus A1 is operating, the conductive-end pressing part 151 may be in contact with the other end of the elastic part 254d, thereby exerting the force on the elastic part 254d. Such force may also exert on the separation contact part 250 and entire developing cartridge 200 to drive the developing cartridge 200 to move along the direction closer to the photosensitive drum, and the developing roller 220 may be in contact with the photosensitive drum. Simultaneously, the elastic part 254d may deform when receiving the force, and the other end of the elastic part 254d may deform along the direction closer to the matching portion 250c, and the gap between the elastic part 254d and the matching portion 250c may become smaller, or the elastic part 254d and the matching portion 250c may be completely in contact with each other, which may generate the pressing force on the separation contact part 250 and also play a cushioning role, such that the developing roller 220 may be in desirable contact with the photosensitive drum. The elastic part 254d and the separation contact part 250 may be formed into a single piece by molding.

In one embodiment, the separation contact part 250 may only have the matching portion 250c exposed outside the conductive-end cover 212.

In one embodiment, the separation assembly may be disposed at one end or two ends of the developing frame.

Other structures of the developing cartridge 200 may be similar to the structures of exemplary embodiment one, which may not be described in detail herein.

### Exemplary Embodiment Five

A developing cartridge 200 is provided in one embodiment. Different from exemplary embodiment one to exemplary embodiment four, the separation assembly may include the separation contact part 250 and an elastic part 254b.

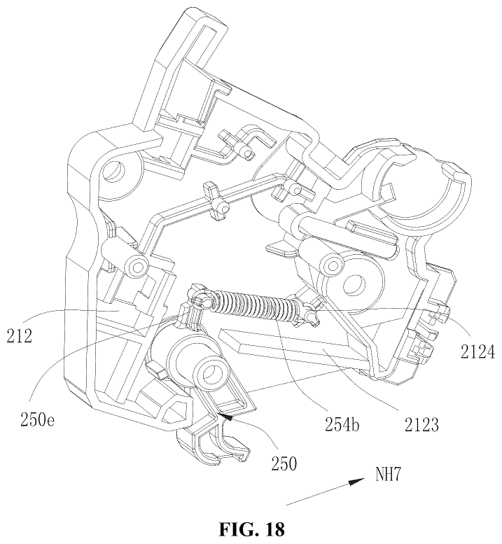

In one embodiment, as shown in FIG. 18, the separation contact part 250 may be rotatably disposed at the conductive-end cover 212 and may receive the force of the image-forming apparatus A1 to move between the first position and the second position. That is, the separation contact part 250 may rotate using the supporting column 2121 as the center. The separation contact part 250 may be disposed with the first connecting block 250e. The first connecting block 250e may be disposed at one end of the connecting portion 250a of the separation contact part 250; that is, the first connecting block 250e and the matching portion 250c may be respectively located at different ends of the separation contact part 250.

As shown in FIG. 18, the elastic part 254b may connect the separation contact part 250 and the developing frame. For example, the second connecting block 2124 may be disposed at the inner side of the conductive-end cover 212. One end of the elastic part 254b may be connected to the first connecting block 250e on the separation contact part 250, and the other end of the elastic part 254b may be connected to the second connecting block 2124. In one embodiment, the elastic part 254b may be a tension spring, which is stretched and deformed when receiving force. When the separation contact part 250 is in the first position, the developing cartridge 200 may be away from the photosensitive drum, the developing roller 220 may be separated from the photosensitive drum, and the elastic part 254b may be not stretched. When the separation contact part 250 moves from the first position to the second position, the developing roller 220 may be in contact with the photosensitive drum, and the elastic part 254b may be stretched to be deformed.

When the image-forming apparatus A1 is operating (when the printing task is in progress), the conductive-end pressing part 151 in the image-forming apparatus A1 may move along the NH7 direction to be abutted against the matching portion 250c of the separation contact part 250. In the process of applying force to the separation contact part 250 to be rotated from the first position to the second position, the force of the conductive-end pressing part 151 may also exert on the developing cartridge 200, and the developing cartridge 200 may rotate along the direction adjacent to the photosensitive drum when receiving the force, such that the developing roller 220 may be in contact with the photosensitive drum. Simultaneously, in the rotation process of the separation contact part 250, one end of the matching portion 250c of the separation contact part 250 may rotate along the direction adjacent to the developing roller 220, and the first connecting block 250e disposed on the other end of the separation contact part 250 may rotate along the direction away from the developing roller 220, such that the elastic part 254b connected to the first connecting block 250e may be stretched. After the elastic part 254b is stretched to be deformed, the elastic part 254b may generate a bias force on the separation contact part 250 along the direction of moving the separation contact part 250 from the second position to the first position. The bias force may also exert on the conductive-end pressing part 151, such that the conductive-end pressing part 151 may also generate a reaction force along the opposite direction to the bias force. The reaction force may exert on the separation contact part 250 and entire developing cartridge 200, such that the developing roller 220 may be further closer to the photosensitive drum and also play a cushioning role. Therefore, desirable contact may be between the developing roller 220 and the photosensitive drum to ensure developing quality.

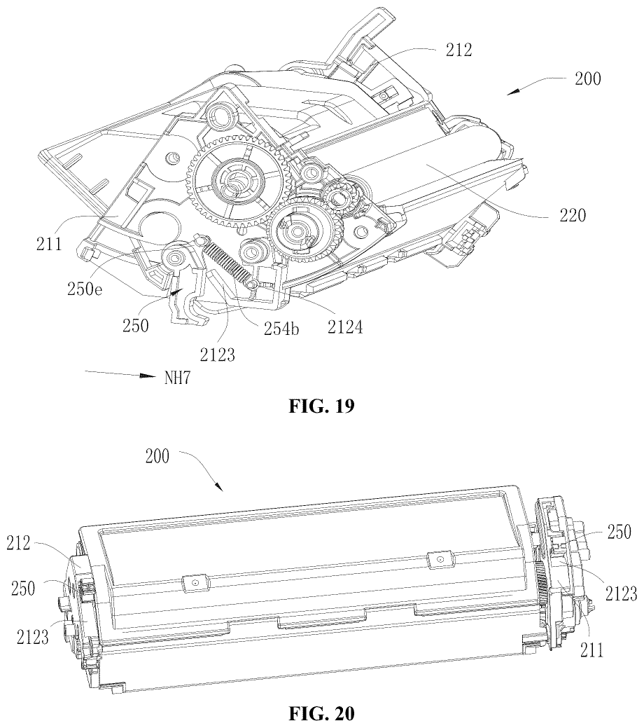

It should be noted that above-mentioned separation assembly may be not limited to being disposed at the conductive end, but may also be disposed at the driving end, and may also be disposed at the driving end and the conductive end. As shown in FIG. 19, when disposed at the driving end, the separation contact part 250 may be disposed at the outer side of the driving-end bearing 211. The second connecting block 2124 may be disposed at the outer side of the driving-end bearing 211, and the elastic part 254b may connect the separation contact part 250 and the driving-end bearing 211. The connection manner herein may be consistent with the connection manner when the separation assembly is disposed at the conductive end, which not be described in detail herein.

Furthermore, as shown in FIGS. 18-20, the developing frame may also be disposed with a rib plate 2123 for blocking the elastic part 254b. When the separation assembly is installed at the conductive end, the rib plate 2123 may be disposed at the inner surface of the conductive-end cover 212. The rib plate 2123 may be located at the lower side of the elastic part 254b. Viewed from the appearance of entire developing cartridge 200, the elastic part 254b may be completely blocked (cannot be observed) by the rib plates 2123 and/or the conductive end covers 212, as shown in FIG. 20. The arrangement of the ribs 2123 may provide protection, which may prevent external parts from entering through gaps and interfering with the operation of the elastic part 254b and/or the separation contact part 250. Similarly, the rib plate 2123 may be also disposed at the outside of the driving-end bearing 211.

Other structures of the developing cartridge 200 may be similar to the structures of exemplary embodiment one, which may not be described in detail herein.

### Exemplary Embodiment Six

A developing cartridge 200 is provided in one embodiment. Compared with the above-mentioned embodiment, the separation assembly may include the separation contact part 250 and an elastic part 254c.

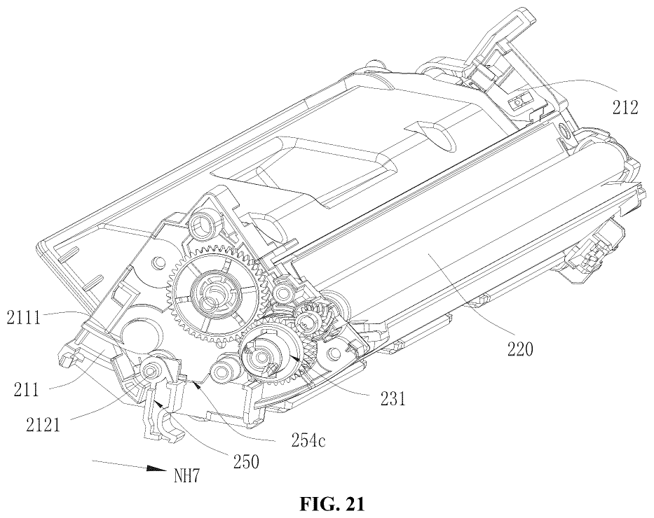

In one embodiment, as shown in FIG. 21, the separation contact part 250 may be rotatably disposed at the outer side of the driving-end bearing 211 and may receive the force of the image-forming apparatus A1 to move between the first position and the second position.

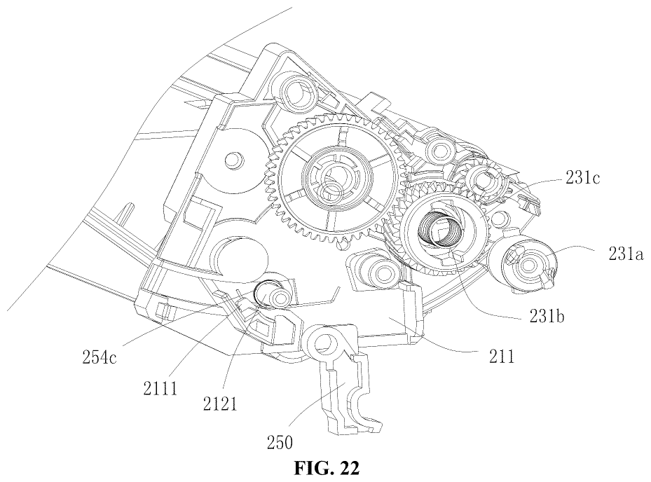

As shown in FIGS. 21-22, the elastic part 254c may be coaxially disposed at the driving-end bearing 211 with the separation contact part 250, one end of the elastic part 254c may be in contact with the driving-end bearing 211, and the other end of the elastic part 254c may be in contact with the separation contact part 250. For example, the elastic part 254c may be a torsion spring, and the coil portion of the torsion spring may be sleeved on the supporting column 2121 on the driving-end bearing 211 and may be closer to the cartridge body 210 than the separation contact part 250. The driving-end bearing 211 may be disposed with a fixing block 2111. One end of the torsion spring may be abutted against between the fixing block 2111 and the inner surface of the driving-end bearing 211, and the other end of the torsion spring may be abutted against the separation contact part 250.

When the image-forming apparatus A1 is operating (when the printing task is in progress), the conductive-end pressing part 151 in the image-forming apparatus A1 may move along the NH7 direction to be abutted against the matching portion 250c of the separation contact part 250. When the force is applied to the separation contact part 250 to rotate the separation contact part 250 from the first position to the second position, the force of the conductive-end pressing part 151 may also exert on the developing cartridge 200, and the developing cartridge 200 may rotate along the direction adjacent to the photosensitive drum when receiving the force, such that the developing roller 220 may be in contact with the photosensitive drum. Simultaneously, during the rotation processing of the separation contact part 250, the other end of the elastic part 254c may be always abutted against the separation contact part 250 and generate a bias force on the separation contact part 250 along the direction which moves the separation contact part 250 from the second position to the first position. The bias force may also exert on the conductive-end pressing part 151, such that the conductive-end pressing part 151 may also generate a reaction force along the opposite direction to the bias force. The reaction force may exert on the separation contact part 250 and entire developing cartridge 200, such that the developing roller 220 may be further closer to the photosensitive drum and also play a cushioning role. Therefore, desirable contact may be between the developing roller 220 and the photosensitive drum to ensure developing quality.

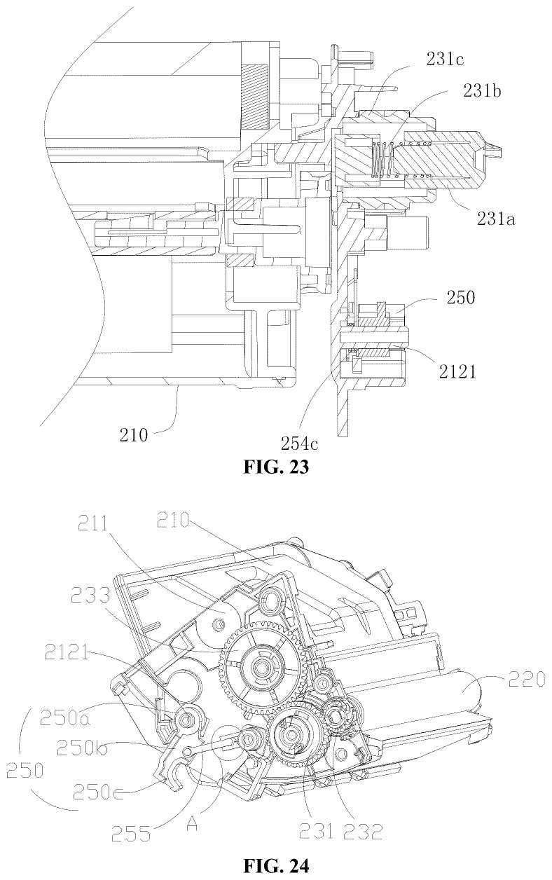

In one embodiment, as shown in FIGS. 22-23, the force-receiving part 231 may include a coupling 231a, a second elastic part 231b and a gear portion 231c; a cavity may be in the middle of the gear portion 231; the coupling 231a may be disposed in the cavity; the second elastic part 231b may be disposed in the cavity; and two ends of the second elastic part 231b may be respectively abutted against the coupling 231a and the bottom wall of the cavity. The coupling 231a may be configured to be meshed with the driving head of the image-forming apparatus A1, thereby receiving the driving force and driving the gear portion 231c to rotate. The gear portion 231c may be configured to be meshed with the developing-roller gear and the stirring-rack gear 233 to transmit the driving force, thereby driving the developing roller 220 and the stirring rack to operate. The second elastic part 231b may play a cushioning role when the coupling 231a is meshed with the driving head, which may prevent collision damage between the coupling 231a and the driving head.

As shown in FIG. 23, when viewed along the direction perpendicular to the rotation axis of the developing roller 220, the second elastic part 231b and the elastic part 254c may be not on same plane. That is, the second elastic part 231b and the elastic part 254c may be not overlapped with each other along the direction of the rotation axis of the developing roller 220. The elastic part 254c may be closer to the cartridge body 210 than the second elastic part 231b.

It should be noted that above-mentioned separation assembly may be not limited to being disposed at the driving end, but may also be disposed at the conductive end, and may also be disposed at the driving end and the conductive end. When disposed at the conductive end, the separation contact part 250 may be disposed at the inner side of the end cover 212 of the conductive end, and the connection manner herein may be consistent with the connection manner when the separation assembly is disposed at the driving end, which may not be described in detail herein.

### Exemplary Embodiment Seven

A developing cartridge is provided in one embodiment. Compared with above-mentioned embodiments, the difference may be that the separation assembly may include a separation contact part and a force-transmission part.

In one embodiment, the separation assembly may include the separation contact part 250 rotatably disposed at the developing frame and a force-transmission part 255 movably connected to the separation contact part 250.

In one embodiment, the separation assembly may be disposed at the driving end of the developing frame. That is, the separation contact part may be rotatably disposed at the outer side of the driving-end bearing 211 (the side away from the cartridge body 210). The separation contact part 250 may receive the force of the image-forming apparatus A1 to move between the first position and the second position. The structure of the separation contact part 250 may be same as the structure of the separation contact part at exemplary embodiment fifth, which may not be described in detail herein.

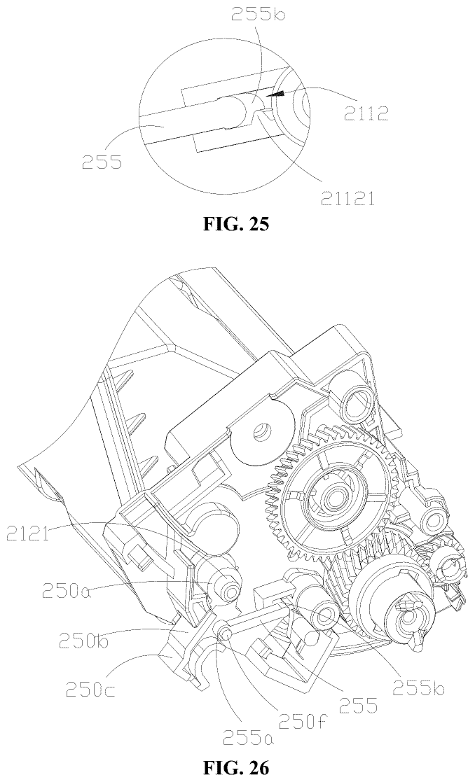

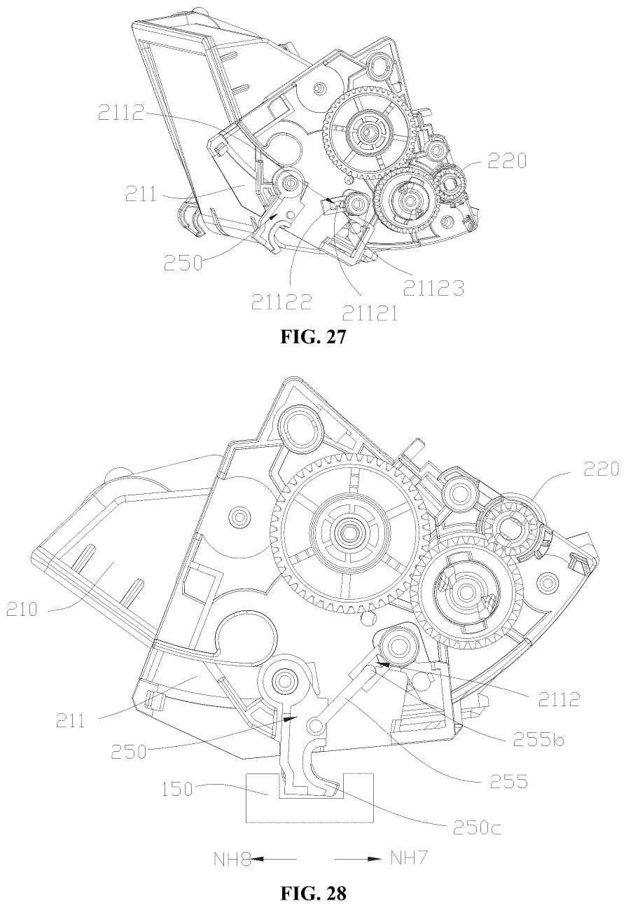

As shown in FIGS. 24-28, the developing frame may be disposed with a guiding-sliding groove 2112. For example, the guiding-sliding groove 2112 may be disposed at the outer surface of the driving-end bearing 211; the guiding-sliding groove 2112 may be disposed with a protruding portion 21121; the protruding portion 21121 may be located approximately in the middle of the guiding-sliding groove 2112; the guiding-sliding groove 2112 may be divided into the first portion 21122 and the second portion 21123 that communicate with each other; and the first portion 21122 may be further away from the developing roller 220 than the second portion 21123.

As shown in FIGS. 24-28, the force-transmission part 255 may be a rod-shaped part; one end of the force-transmission part 255 may be hinged with the separation contact part 250, and the other end of the force-transmission part 255 may be slidingly connected to the guiding-sliding groove 2112. When the force-transmission part 255 is driven to move by the separation contact part 250, the other end of the force-transmission part 255 may slide along the guiding-sliding groove 2112. For example, one end of the force-transmission part 255 may be disposed with a rotating portion 255a; the separation contact part 250 may be disposed with a rotation fixing portion 250f that matches the rotating portion 255a; the rotating portion 255a may be a through hole formed at one end of the force-transmission part 255; the rotation fixing portion 250f may be a supporting axle disposed on the rod portion 250b of the separation contact part 250; and the force-transmission part 255 may be rotatably disposed on the separation contact part 250 by matching the supporting axle and the through hole. Optionally, the rotating portion 255a may be also configured as the supporting axle, the rotating fixing portion 250f may be also configured as the through hole, and the supporting axle may be configured to be a separated part or an integrated part. The other end of the force-transmission part 255 may be disposed with a sliding portion 255b. The sliding portion 255b may be slidingly connected with the guiding-sliding groove 2112. The sliding portion 255b may be a column-shaped part or a block-shaped part that extends and/or protrudes from the surface of the force-transmission part 255 toward the direction of the cartridge body 210. During installation, the surface of the force-transmission part 255 facing the cartridge body 210 may be in contact with the surface of the guiding-sliding groove 2112 facing away from the cartridge body 210; the sliding portion 255b may be inserted into the guiding-sliding groove 2112; one end of the second portion 21123 of the guiding-sliding groove 2112 adjacent to the developing roller 220 may be closed or partially closed; and one end of the first portion 21122 away from the developing roller 220 may be closed or partially closed, thereby preventing the sliding portion 255b from being separated from the guiding-sliding groove 2112 when the sliding portion 255b slides along the guiding-sliding groove 2112.

The sliding portion 255b may slide over the protruding portion 21121 under the force of the image-forming apparatus (for example, the force exerted by the driving-end pressing part 150 on the separation contact part 250 may be transmitted to the force-transmission part 255 to move the sliding portion 255b); and the protruding portion 21121 may play a limiting role. In such way, the sliding portion 255b may be stabilized in the first portion 21122 or the second portion 21123. The protruding portion 21121 may be elastic or rigid.

As shown in FIG. 28, when the image-forming apparatus is operating (when a printing task is in progress), the driving-end pressing part 150 in the image-forming apparatus may move along the NH7 direction to be abutted against the side of the matching portion 250c of the separation contact part 250 away from the developing roller 220 and exert the force (the pushing force) to the separation contact part 250; and the separation contact part 250 may rotate counterclockwise around the supporting column 2121 and move from the first position to the second position. Simultaneously, the separation contact part 250 may drive the force-transmission part 255 movably connected with the separation contact part 250 to move, such that the sliding portion 255b of the force-transmission part 255 may pass over the protruding portion 2221 and move from the first portion 21122 of the guiding-sliding groove 2112 to the second portion 21123; the sliding portion 255b may move to be abutted against the end of the guiding-sliding groove 2112 adjacent to the developing roller 220, such that the separation contact part 250 may receive the pushing force; and the force may exert on entire developing cartridge through the force-transmission part 255, such that the developing cartridge may move along the direction adjacent to the photosensitive drum when receiving the force, thereby making the developing roller 220 to be in contact with the photosensitive drum.

As shown in FIG. 28, when the image-forming apparatus finishes printing, the driving-end pressing part 150 in the image-forming apparatus may move along the NH8 direction to be abutted against the matching portion 250c of the separation contact part 250 on the side adjacent to the developing roller 220 and exert the force (the pushing force) to the separation contact part 250; and the separation contact part 250 may rotate clockwise to move from the second position to the first position. Simultaneously, the separation contact part 250 may drive the force-transmission part 255 to move, such that the sliding portion 255b of the force-transmission part 255 may pass over the protruding portion 21121 and move from the second portion 21123 of the guiding-sliding groove 2112 to the first portion 21122; the sliding portion 255b may move to be abutted against the end of the guiding-sliding groove 2112 away from the developing roller 220, such that the separation contact part 250 may receive the pushing force; and the force may exert on entire developing cartridge through the force-transmission part 255, such that the developing cartridge may move along the direction away from the photosensitive drum after receiving the force, thereby making the developing roller 220 to be in contact with the photosensitive drum.

It should be noted that above-mentioned separation assembly may be not limited to being disposed at the driving end, but may also be disposed at the conductive end, or may be disposed at both the driving end and the conductive end. When disposed at the conductive end, the separation contact part 250 and the force-transmission part 255 may be disposed at the inner side of the end cover 212 of the conductive end or on the end surface of the cartridge body 210 at the conductive end. The supporting column 2121, the guiding-sliding groove 2112 and other structures may be disposed at the inner side of the conductive-end cover 212 or on the end surface of the cartridge body 210 at the conductive end; and the connection manner herein may be consistent with the connection manner when the separation assembly is disposed at the driving end, which may not be described in detail herein.

### Exemplary Embodiment Eight

Another developing cartridge is provided in one embodiment. Compared with above-mentioned embodiments, the structure of the separation assembly may be different.

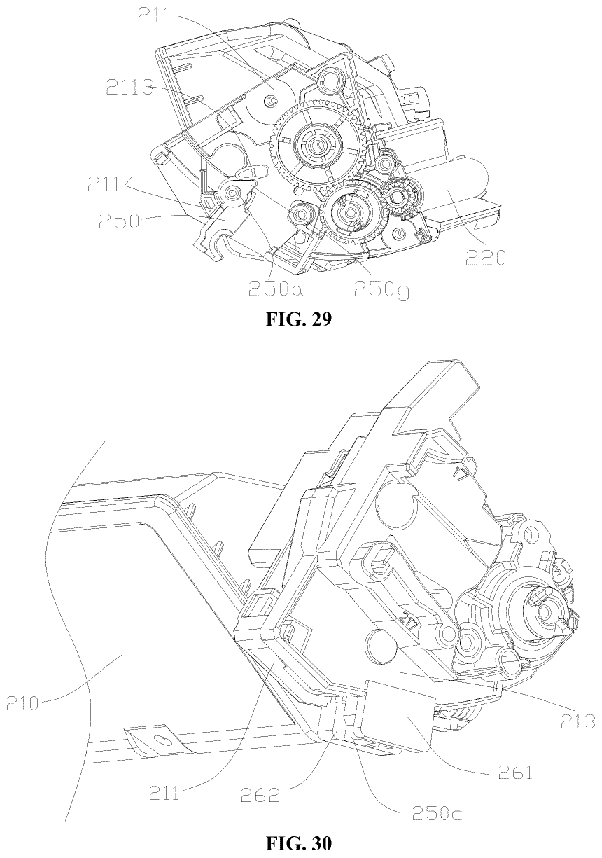

As shown in FIG. 29, in one embodiment, the separation assembly may include the separation contact part 250, the first limiting portion 2113 and the second limiting portion 2114. The structure of the separation contact part 250 may be same as the structure of the separation contact part 250 at exemplary embodiment one and may be disposed on the driving-end bearing 211. The connecting portion 250a of the separation contact part 250 may be disposed with a protruding block 250g for being abutted against the first limiting portion 2113. The first limiting portion 2113 may be disposed on the outer surface of the driving-end bearing 211 and located above the supporting column 2121. The first limiting portion 2113 may include a column portion disposed by protruding along the direction away from the cartridge body 210 and a ring portion disposed at one end of the column portion away from the cartridge body 210. The connecting portion 250a may be disposed with the upwardly protruding block 250g that may reach a position that is abutted against the ring portion of the first limiting portion 2113. Moreover, the protruding block 250g may be abutted against the side of the ring portion adjacent to the developing roller 220, and the ring portion may deform to a small extent when being subjected to a certain external force. The second limiting portion 2114 may be a part of the driving-end bearing 211. The second limiting portion 2114 may be on the side of the separation contact part 250 away from the developing roller 220 and may be abutted against the separation contact part 250. That is, the first limiting portion 2113 and the second limiting portion 2114 may be respectively abutted against different sides of the separation contact part 250, such that the rotation of the separation contact part 250 may be limited.

When the image-forming apparatus is operating (when the printing task is in progress), the driving-end pressing part 150 in the image-forming apparatus may move along the NH7 direction to be abutted against the matching portion 250c of the separation contact part 250 on the side away from the developing roller 220 and exert the force (the pushing force) to the separation contact part 250, such that the separation contact part 250 may have a tendency to rotate counterclockwise. However, since the protruding block 250g of the separation contact part 250 is abutted against the ring portion of the first limiting portion 2113, the separation contact part 250 may not rotate. The pushing force received by the separation contact part 250 may exert on entire developing cartridge, such that the developing cartridge may move along the direction adjacent to the photosensitive drum. In such way, the developing roller 220 may be in contact with the photosensitive drum. In addition, the pressing force of the separation contact part 250 on the first limiting portion 2113 may slightly deform the ring portion of the first limiting portion 2113; and the force generated by the deformation of the ring portion may also react on the developing cartridge, which may make the developing roller 220 further closer to the photosensitive drum and also play a cushioning role. Therefore, desirable contact may be between the developing roller 220 and the photosensitive drum to ensure developing quality.

After the image-forming apparatus finishes printing, the driving-end pressing part 150 in the image-forming apparatus may move along the NH8 direction to be abutted against the matching portion 250c of the separation contact part 250 on the side adjacent to the developing roller 220 and exert the force (the pushing force) on the separation contact part 250, such that the separation contact part 250 may have tendency to rotate clockwise. However, since the separation contact part 250 is abutted against the second limiting portion 2114, the separation contact part 250 may not rotate. The pushing force received by the separation contact part 250 may exert on entire developing cartridge, which may make the developing cartridge to move along the direction away from the photosensitive drum after receiving the force, such that the developing roller 220 may be separated from the photosensitive drum.

It should be noted that above-mentioned separation assembly may be not limited to being disposed at the driving end, but may also be disposed at the conductive end, and may also be disposed at the driving end and the conductive end.

Other structures of the developing cartridge may be similar to the structures in exemplary embodiment one, which may not be described in detail herein.

### Exemplary Embodiment Nine

Another developing cartridge is provided in one embodiment. Compared with the above-mentioned embodiments, the difference may be that the developing cartridge may also include a guarding-plate structure for protecting the separation contact part 250.

As shown in FIG. 30, in order to facilitate matching between the matching portion 250c of the separation contact part 250 and the driving-end pressing part 150, the matching portion 250c may protrude from the cartridge body 210. During transportation process, the matching portion 250c of the separation contact part 250 may be easily damaged by impact and collision, and even entire separation contact part 250 may be damaged, which may affect the function of the separation assembly. Therefore, a guarding-plate structure may be disposed to protect the separation contact part 250, which may prevent damage to the force-receiving parts during transportation process to affect the quality of the developing cartridge.

For example, as shown in FIG. 30, the guarding-plate structure may include the first guarding plate 261 and the second guarding plate 262 which are respectively located on two sides of the separation contact part 250. The first guarding plate 261 and the second guarding plate 262 may be (rectangular) plate-shaped parts. The first guarding plate 261 may be disposed on the lower edge of the driving-end cover 213, and the second guarding plate 262 may be disposed on the lower edge of the driving-end bearing 211. The first guarding plate 261 and the second guarding plate 262 may be arranged oppositely along the length direction of the cartridge body 210. The matching portion 250c of the force-receiving part may be between the first guarding plate 261 and the second guarding plate 262. In addition, along the height direction, the separation contact part 250 may not protrude from the guarding-plate structure, and the separation contact part 250 may be completely covered by the first guarding plate 261 and the second guarding plate 262, thereby protecting the separation contact part 250 and preventing the separation contact part 250 from being damaged during transportation process. During usage, the driving-end pressing part 150 may be in contact with the matching portion 250c from between the first guarding plate 261 and the second guarding plate 262; and the moving direction of the driving-end pressing part 150 and the moving direction of the force-receiving part may be both perpendicular to the length direction of the cartridge body 210, the guarding-plate structure may not cause interference, and the separation assembly may normally perform corresponding functions.

It should be noted that when the separation assembly is disposed at the conductive end, the guarding-plate structure may be disposed oppositely on the conductive-end cover 212 and the cartridge body 210; and when the separation assembly is disposed at the driving end and the conductive end, the guarding-plate structure may be disposed at both the driving end and the conductive end.

### Exemplary Embodiment Ten

When the developing cartridge is installed on the image-forming apparatus to prepare for the developing operation, installation detection may be performed through the cooperation between the image-forming apparatus and the developing cartridge, which may ensure that the developing cartridge is installed in the correct position to make the image-forming apparatus perform developing operation normally. Some image-forming apparatuses may identify relevant information of the developing cartridge (such as capacity, color, model or the like) through installation detection. Therefore, if the installation detection device is unstable, the developing cartridge may not be operated normally.

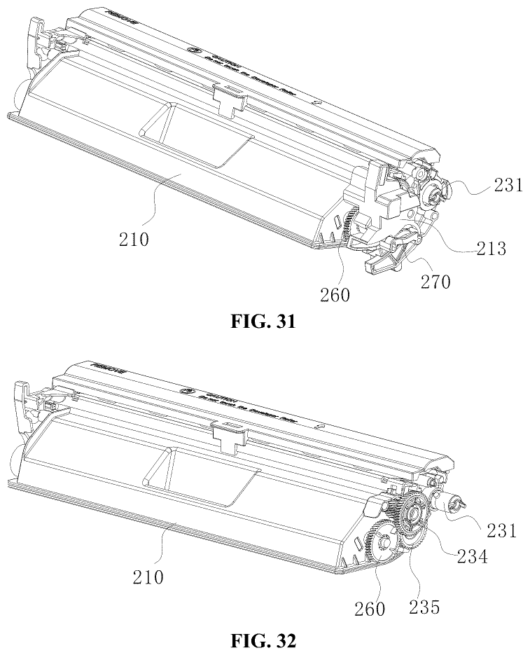

As shown in FIGS. 31-32, a developing cartridge is provided in one embodiment. Compared with above-mentioned embodiments, the developing cartridge may also include an assembly to-be-detected for cooperating with the image-forming apparatus to complete the installation detection of the developing cartridge. The image-forming apparatus (not shown) may be also disposed with an installation detection device (not shown). The installation detection device may include a swing-guiding part (not shown). The swing-guiding part may be installed in the image-forming apparatus through a connecting rod, and the swing-guiding part may swing in the image-forming apparatus using the connecting rod as the center. When the developing cartridge is installed in the image-forming apparatus, the developing cartridge may cooperate with the swing-guiding part to drive the swing-guiding part to swing and cooperate with other structures of the image-forming apparatus, thereby jointly completing the installation detection of the developing cartridge.

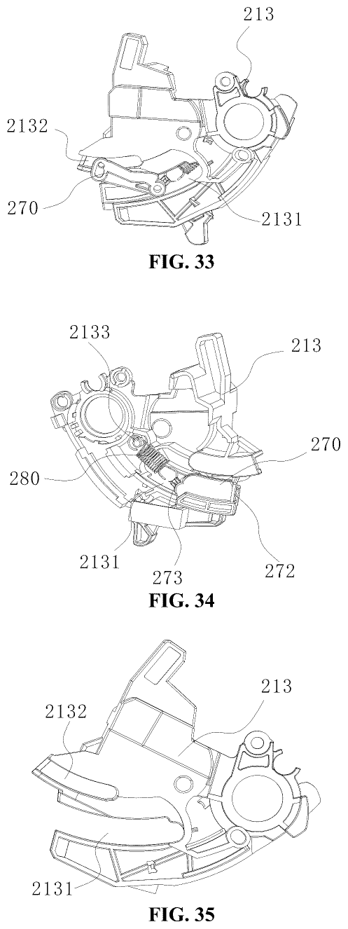

As shown in FIGS. 31-34, the assembly to-be-detected may include a part to-be-detected 270 and a rotating part 260. The rotating part 260 may rotate under the driving of the driving assembly; and the part to-be-detected 270 may be directly or indirectly driven by the rotating part 260 to trigger the swing-guiding part in the image-forming apparatus.

As shown in FIGS. 31-32, in one embodiment, the driving assembly may be disposed between the outer side of the cartridge body 210 and the driving-end cover 213. The driving assembly may include the force-receiving part 231, the developing-roller gear, the first transmission gear 234 and the second transmission gear 235. The force-receiving part 231 may be configured to receive the driving force of the image-forming apparatus A1 and transmit the driving force, thereby driving the developing roller 220 and the stirring rack to rotate and driving the assembly to-be-detected to operate. The developing-roller gear may be fixed to one end of the axle of the developing roller 220 along the length direction. The developing-roller gear may be meshed with the gear portion of the force-receiving part 231, such that the developing roller 220 may receive the driving force to rotate. The first transmission gear 234 may be rotatably supported on the driving end of the cartridge body 210. The first transmission gear 234 may be a two-stage coaxial gear, including a large gear portion and a small gear portion which are configured coaxially. The large gear portion may be further away from the cartridge body 210 than the small gear portion. The large gear portion may be meshed with the gear portion of the force-receiving part 231, and the small gear portion may be meshed with the second transmission gear. That is, when the force-receiving part 231 receives the driving force of the image-forming apparatus to rotate, the force-receiving part 231 may drive the first transmission gear 234 to rotate, and the rotation of the first transmission gear 234 may drive the second transmission gear 235 to rotate. The second transmission gear 235 may be connected to one end of the mixing frame along the length direction. That is, when the second transmission gear 235 rotates, the second transmission gear 235 may drive the mixing frame to rotate synchronously. That is, the second transmission gear 235 is also called the stirring-rack gear.

As shown in FIGS. 31, 32 and 38, the rotating part 260 may be a gear member rotatably supported at the outer side of the driving end of the cartridge body 210. The rotating part 260 may include a tooth portion 261, a tooth-less portion 262 and a protruding portion 263. The tooth portion 261 may be disposed on the outer circumferential surface of the rotating part 260. The tooth portion 261 may be meshed with the second transmission gear 235, such that the rotating part 260 may be driven by the second transmission gear 235. The tooth portion 261 may not completely cover the outer circumferential surface of the rotating part 260. The outer circumferential surface of the rotating part 260 may be disposed with a part without the tooth portion 261, that is the tooth-less portion 262. When the rotating part 260 rotates until the tooth-less portion 262 is opposite to the second transmission gear 235, the tooth portion 261 may be de-meshed with the second transmission gear 235, and the rotating part 260 may no longer be driven by the second transmission gear 235.

As shown in FIGS. 32 and 38, the protruding portion 263 may be disposed on the end surface of the rotating part 260 facing away from the cartridge body 210, and the number of the protruding portions 263 may be at least one. In one embodiment, the number of the protruding portions 263 may be configured to be three, and three protruding portions 263 may be arranged in a circular array on the end surface of the rotating part 260. The protruding portion 263 may contact and drive the part to-be-detected 270 to move when the rotating part 260 rotates.

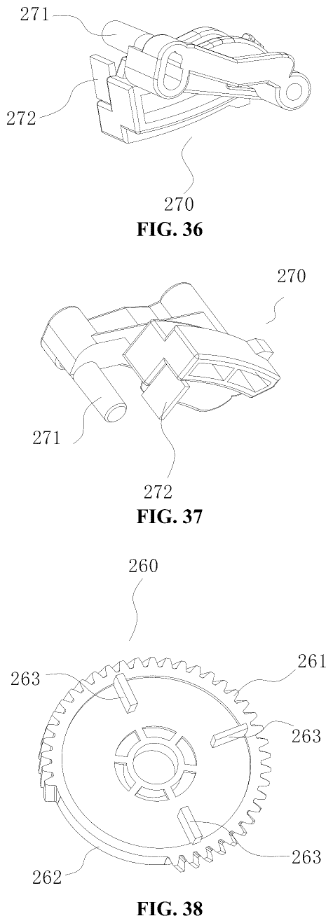

As shown in FIGS. 31 and 33-37, the part to-be-detected 270 may be movably disposed on the driving-end cover 213. The part to-be-detected 270 may be a sliding block. The driving-end cover 213 may be disposed with a sliding groove 2131. The sliding groove 2131 may be a through groove passing through the inside and outside of the driving-end cover 213. The part to-be-detected 270 may be at least partially inserted in the sliding groove 2131, such that the part to-be-detected 270 may slide in the sliding groove 2131. In addition, the part to-be-detected 270 may be at least partially protruded and exposed outside the outer side of the driving-end cover 213, such that when the part to-be-detected 270 moves, the swing-guiding part in the image-forming apparatus may be conveniently triggered. The sliding groove 2131 may approximately be an arc-shaped groove; that is, the sliding trajectory of the part to-be-detected 270 may be also arc-shaped. The extending direction of the sliding groove 2131 may be approximately along the width direction of the cartridge body 210.

Furthermore, as shown in FIGS. 35-37, a limiting groove 2132 may be disposed on the outer surface of the driving-end cover 213, and a limiting column 271 may be disposed on the part to-be-detected 270. When the part to-be-detected 270 is installed in the sliding groove 2131, the limiting column 271 may be at least partially inserted in the limiting groove 2132. When the part to-be-detected 270 slides in the sliding groove 2131, the limiting column 271 may also slide in the limiting groove 2132. The cooperation between the limiting column 271 and the limiting groove 2132 may limit the position of the part to-be-detected 270, such that the part to-be-detected 270 more stable when the part to-be-detected 270 slides.

As shown in FIGS. 34 and 36-38, the side of the part to-be-detected 270 facing the rotating part 260 may be disposed with an abutting portion 272 for cooperating with the protruding portion 263 on the rotating part 260. In such way, when the rotating part 260 rotates, the protruding portion 263 may be abutted against the abutting portion 272 to exert the force on the abutting portion 272. Therefore, the part to-be-detected 270 may be driven to slide along the slide groove 2131 to contact the swing-guiding part. Each protruding portion 263 on the rotating part 260 may drive the part to-be-detected 270 to slide once. In one embodiment, the number of protruding portions 263 may be configured to be three, that is, the part to-be-detected 270 may be driven to slide three times.

As shown in FIG. 34, the part to-be-detected 270 may need to be reset to its initial position each time after the part to-be-detected 270 is driven to slide by the protruding portion 263, such that next protruding portion 263 may conveniently contact the abutting portion 272. The assembly to-be-detected may also include a resetting part 280 for resetting the part to-be-detected 270. The resetting part 280 may be connected between the part to-be-detected 270 and the driving-end cover 213. When the part to-be-detected 270 is driven to slide by the protruding portion 263, the resetting part 280 may elastically deform to store elastic potential energy. After the protruding portion 263 rotates to pass over the abutting portion 272, the pushing force exerted on the abutting portion 272 by the protruding portion 263 may disappear, deformation recovery of the resetting part 280 may release elastic potential energy, which may drive the part to-be-detected 270 to slide along the opposite direction to return to the initial position and may wait for next protruding portion 263 to be rotated in place before being driven again. For example, the resetting part 280 may be a tension spring, the driving-end cover 213 may be disposed with the first elastic hook portion 2133, and the part to-be-detected 270 may be disposed with the second elastic hook portion 273. One end of the resetting part 280 may be connected to the first elastic hook part 2133, and the other end of the resetting part 280 may be connected to the second elastic hook part 273. Optionally, the resetting part 280 may also be another part that may provide elastic restoring force, including a compression spring, elastic rubber, an elastic sponge, a spring leaf, or the like; or may also be another structure using inelastic force.

As shown in FIGS. 31-38, after the developing cartridge is installed in the image-forming apparatus, the installation and detection process of the developing cartridge part is described hereinafter.

The developing cartridge may be installed in the image-forming apparatus; the driving head in the image-forming apparatus may be meshed with the force-receiving part 231; the rotation of the driving head may drive the force-receiving part 231 to rotate, which may transmit the driving force to the first transmission gear 234, the second transmission gear 235 and the rotating part 260; during the rotation process of the rotating part 260, the protruding portion 263 may be abutted against the abutting portion 272 on the part to-be-detected 270 and exert the pushing force on the abutting portion 272 and push the part to-be-detected 270 to slide in the sliding groove 2131; when the part to-be-detected 270 slides, the part to-be-detected 270 may contact the swing-guiding part in the image-forming apparatus and make the swing-guiding part to swing; when the part to-be-detected 270 slides, the part to-be-detected 270 may drive the resetting part 280 to deform; as the rotating part 260 continues to rotate, the protruding portion 263 may rotate over the position of being abutted against the abutting portion 272, the pushing force on the part to-be-detected 270 may disappear, and the part to-be-detected 270 may be reset to the initial position under the elastic restoring force of the resetting part 280; and when the rotating part 260 rotates until next protruding portion 263 is abutted against the abutting portion 272, above process may be repeated. The number of the protruding portions 263 on the rotating part 260 may be configured to be three in one embodiment. Therefore, the protruding portions 263 may push the part to-be-detected 270 three times, and the swing-guiding part of the image-forming apparatus may also be triggered three times. When the image-forming apparatus identifies the signal generated when the swing-guiding part moves three times, it determines that the installation detection may be completed.

After the rotating part 260 is driven by the second transmission gear 235 to rotate over of the tooth portion 261, the rotating part 260 may reach the position where the tooth-less portion 262 is opposite to the second transmission gear 235′ and the tooth portion 261 may be de-meshed from the second transmission gear 235. Subsequently, the rotation of the second transmission gear 235 may no longer drive the rotating part 260 to rotate.

The developing cartridge of one embodiment may be disposed with the assembly to-be-detected, which may directly or indirectly receive the driving force of the image-forming apparatus to operate. The rotating part 260 may drive the part to-be-detected 270 to move during the driving process, thereby being cooperated with the installation detection device (including the swing-guiding part) of the image-forming apparatus to complete the installation detection, which may have a simple structure and stable usage and may desirably perform the installation detection of the developing cartridge.

In some other embodiments, the number of protruding portions 263 on the rotating part 260 may be configured to be more or less; and the spacing, the arc length and the like between the protruding portions 263 may also be changed, thereby changing the number of triggering times, the contact interval, the contact duration and the like of the swing-guiding part. In such way, the image-forming apparatus may detect developing cartridges of different models, capacities, and lifespans.

In some other embodiments, the assembly to-be-detected may also be disposed at the conductive end of the developing cartridge or may be disposed at both the driving end and the conductive end of the developing cartridge.

The above may be only optional embodiments of the present disclosure. Any changes or substitutions, which are made by those skilled in the art and within the spirit and principle of the present disclosure, shall be included in the protection scope of the present disclosure.

What is claimed is:

1. A developing cartridge, comprising:
a developing roller, having a rotation axis;
a developing frame, configured to support the developing roller, wherein the developing frame includes a cartridge body, a driving-end cover and a conductive-end cover; and the driving-end cover is at an end of the cartridge body along a length direction of the cartridge body, and the conductive-end cover is at another end of the cartridge body along the length direction of the cartridge body;
a separation contact part, connected to the conductive-end cover, wherein the separation contact part is capable of rotating relative to the conductive-end cover;
a tension spring, connected to the conductive-end cover and the separation contact part, wherein when the separation contact part rotates relative to the conductive-end cover, the tension spring is stretched;
a force-receiving part, at an end of the cartridge body along the length direction of the cartridge body and disposed at a same end as the driving-end cover, wherein the force-receiving part is configured to receive and transmit a driving force to rotate the developing roller; and
an electrode assembly, wherein the electrode assembly is at an inner side of the conductive-end cover and electrically connected to an end of the developing roller; and an opening is formed on the conductive-end cover, and a portion of the electrode assembly is exposed through the opening.

2. The developing cartridge according to claim 1, further including:
another separation contact part and another tension spring, wherein the developing frame further includes a driving-end bearing; the driving-end bearing is disposed between the cartridge body and the driving-end cover along the length direction of the cartridge body; the another separation contact part is rotatably connected to the driving-end bearing, and the another tension spring is connected to the driving-end bearing and the another separation contact part; and when the another separation contact rotates relative to the driving-end bearing, the another tension spring is stretched.

3. The developing cartridge according to claim 2, further including:
a developing-roller gear and a stirring-rack gear, wherein the force-receiving part, the developing-roller gear and the stirring-rack gear are disposed on an outer side of the driving-end bearing; the force-receiving part is capable of directly or indirectly being meshed with the developing-roller gear and the stirring-rack gear to transmit the driving force; and when viewed along the rotation axis direction of the developing roller, the another tension spring is disposed to be not overlapped with the stirring-rack gear.

4. The developing cartridge according to claim 1, wherein:
an end of the separation contact part is a connecting portion, and another end of the separation contact part is a matching portion; the connecting portion is connected to a supporting column on an inner side of the conductive-end cover; the matching portion is exposed from the conductive-end cover; and when the separation contact part rotates relative to the conductive-end cover, the matching portion moves toward a direction adjacent to the developing roller.

5. The developing cartridge according to claim 4, wherein:
the separation contact part is disposed with a first connecting block, and the conductive-end cover is disposed with a second connecting block; and an end of the tension spring is connected to the first connecting block, and another end of the tension spring is connected to the second connecting block.

6. The developing cartridge according to claim 4, wherein:
the separation contact part further includes a rod portion connected to the connecting portion and the matching portion; a limiting portion is further disposed on the inner side of the conductive-end cover; and the limiting portion is capable of being in contact with the rod portion of the separation contact part and located below the supporting column.

7. The developing cartridge according to claim 6, wherein:
when the tension spring is not stretched to be deformed, the limiting portion is in contact with the rod portion of the separation contact part to limit movement of the separation contact part along a direction away from the developing roller.

8. The developing cartridge according to claim 7, further including:
a guarding plate at a lower edge of the driving-end cover, wherein along a height direction of the developing cartridge, the mating portion of the separation contact part does not protrude downward from the guarding plate.

9. The developing cartridge according to claim 1, further including:
a stirring rack and a stirring-rack gear, wherein the stirring rack is rotatably disposed in the cartridge body; the stirring-rack gear is disposed between the driving-end cover and the cartridge body along the length direction of the cartridge body; and the stirring-rack gear rotates the stirring rack by receiving the driving force from the force-receiving part.

10. The developing cartridge according to claim 9, further including:
a developing-roller gear, wherein the force-receiving part includes a coupling and a gear portion; the developing frame further includes a driving-end bearing; the driving-end bearing is disposed between the cartridge body and the driving-end cover along the length direction of the cartridge body; and the developing-roller gear, the gear portion and the stirring-rack gear are all disposed at an outer side of the driving-end bearing and between the driving-end bearing and the driving-end cover.

11. The developing cartridge according to claim 10, further including:
another separation contact part and another tension spring, wherein the another separation contact part is rotatably connected to the driving-end bearing; two ends of the another tension spring are respectively connected to the driving-end bearing and the another separation contact part; when another separation contact part rotates relative to the driving-end bearing, the another tension spring is stretched; and when viewed along the rotation axis direction of the developing roller, the another tension spring is disposed to be not overlapped with the stirring-rack gear.

12. The developing cartridge according to claim 10, wherein:
an end of the another separation contact part is disposed with a matching portion; the mating portion makes the another separation contact part to rotate relative to the driving-end bearing under action of an external force; and along a height direction of the developing cartridge, the matching portion protrudes downward from the cartridge body, the stirring-rack gear is on the another tension spring, and the another tension spring is on the matching portion.

13. A developing cartridge, comprising:
a developing roller, having a rotation axis;
a developing frame, configured to support the developing roller, wherein the developing frame includes a cartridge body, a driving-end cover and a conductive-end cover; and the driving-end cover is at an end of the cartridge body along a length direction of the cartridge body, and the conductive-end cover is at another end of the cartridge body along the length direction of the cartridge body;
a first separation contact part, connected to the conductive-end cover, wherein the first separation contact part is capable of rotating between a first position and a second position relative to the conductive-end cover;
a first tension spring, connected to the conductive-end cover and the first separation contact part, wherein when the first separation contact part rotates from the first position to the second position relative to the conductive end cover, the first tension spring is stretched;
a force-receiving part, at an end of the cartridge body along the length direction of the cartridge body and disposed at a same end as the driving-end cover, wherein the force-receiving part is configured to receive and transmit a driving force to rotate the developing roller; and
a conductive part, wherein the conductive part is at an inner side of the conductive-end cover and electrically connected to an end of the developing roller; and an opening is formed on the conductive-end cover, and a portion of the conductive part is exposed through the opening.

14. The developing cartridge according to claim 13, wherein:
when an external force does not act on the first separation contact part, the first separation contact part is in the first position, and the first tension spring is not stretched; and when the external force acts on the first separation contact part, the first separation contact part is capable of rotating from the first position to the second position under action of the external force, and the first tension spring is stretched to be deformed.

15. The developing cartridge according to claim 14, wherein:
a matching portion is disposed at an end of the first separation contact part; the matching portion protrudes downward from the cartridge body along a height direction of the developing cartridge; and when the first separation contact part rotates from the first position to the second position, the matching portion moves toward a direction adjacent to the developing roller.

16. The developing cartridge according to claim 13, further including:
a stirring-rack gear, a second separation contact part and a second tension spring, wherein the developing frame further includes a driving-end bearing; the second separation contact part is rotatably connected to the driving-end bearing; an end of the second tension spring is connected to the second separation contact part, and another end of the second tension spring is connected to the drive-end bearing; the driving-end bearing is disposed between the cartridge body and the driving-end cover along the length direction of the cartridge body; the stirring-rack gear, the second separation contact part and the second tension spring are disposed at an outer side of the driving-end bearing; and when viewed along the rotation axis direction of the developing roller, a portion of the second separation contact part protrudes from the cartridge body, and the second tension spring is not overlapped with the stirring-rack gear.

17. A developing cartridge, comprising:
a developing roller, having a rotation axis;
a developing frame, configured to support the developing roller, wherein the developing frame includes a cartridge body, a driving-end cover, a conductive-end cover, and a driving-end bearing; the driving-end bearing at an end of the cartridge body along a length direction of the cartridge body, and the conductive-end cover is at another end of the cartridge body along the length direction of the cartridge body; and the driving-end cover is disposed at an outer side of the drive-end bearing;
a first swing rod, connected to the conductive-end cover, wherein the first swing rod is capable of rotating between a first position and a second position relative to the conductive-end cover;
a second swing rod, connected to the drive-end bearing, wherein the second swing rod is capable of rotating between the first position and the second position relative to the driving-end bearing;
a first tension spring, connected to the conductive-end cover and the first swing rod, wherein when the first swing rod rotates from the first position to the second position relative to the conductive-end cover, the first tension spring is stretched to be deformed;
a second tension spring, connected to the driving-end bearing and the second swing rod, wherein when the second swing rod rotates from the first position to the second position relative to the driving-end bearing, the second tension spring is stretched to be deformed;
a force-receiving part, disposed on the driving-end bearing, wherein the force-receiving part is configured to receive and transmit a driving force to rotate the developing roller; and
a conductive part, wherein the conductive part is at an inner side of the conductive-end cover and electrically connected to an end of the developing roller; and an opening is formed on the conductive-end cover, and a portion of the conductive part is exposed through the opening.

18. The developing cartridge according to claim 17, further including:
a developing-roller gear, a stirring rack and a stirring-rack gear, wherein the stirring rack is rotatably disposed in the cartridge body; the developing-roller gear and the stirring-rack gear are disposed at an outer side of the driving-end bearing; and the force-receiving part is capable of directly or indirectly being meshed with the developing-roller gear and the stirring-rack gear to transmit the driving force to the developing roller and the stirring rack, thereby rotating the developing roller and the stirring rack.

19. A developing cartridge, comprising:
a developing roller, having a rotation axis;
a developing frame, configured to support the developing roller, wherein the developing frame includes a cartridge body, a driving-end cover, a conductive-end cover, and a driving-end bearing; the driving-end bearing at an end of the cartridge body along a length direction of the cartridge body, and the conductive-end cover is at another end of the cartridge body along the length direction of the cartridge body; and the driving-end cover is disposed at an outer side of the drive-end bearing;
a first separation contact part, connected to the conductive-end cover, wherein the first separation contact part is capable of rotating relative to the conductive-end cover;
a second separation contact part, connected to the driving-end bearing, wherein the second separation contact part is capable of rotating relative to the driving-end bearing;
a first tension spring, connected to the conductive-end cover and the first separation contact part, wherein when the first separation contact part rotates relative to the conductive-end cover, the first tension spring is stretched to be deformed;
a second tension spring, connected to the driving-end bearing and the second separation contact part, wherein when the second separation contact part rotates relative to the driving-end bearing, the second tension spring is stretched to be deformed;
a force-receiving part, at an end of the developing frame along the length direction of the cartridge body and disposed at a same end as the driving-end cover, wherein the force-receiving part is configured to receive and transmit a driving force to rotate the developing roller; and
a conductive part, wherein the conductive part is at an inner side of the conductive-end cover and electrically connected to an end of the developing roller; and an opening is formed on the conductive-end cover, and a portion of the conductive part is exposed through the opening.

20. The developing cartridge according to claim 19, wherein:
a matching portion is disposed at each of an end of the first separation contact part and an end of the second separation contact part; along a height direction of the developing cartridge, the mating portion of the first separation contact part is exposed from the conductive-end cover, and the mating portion of the second separation contact part protrudes downward from the cartridge body; and when the first separation contact part rotates relative to the conductive-end cover, the matching portion of the first separation contact part moves toward a direction adjacent to the developing roller.
